(19) United States
(12) Patent Application Publication
(10) Pub. No.: US 2007/0040883 A1
(43) Pub. Date: Feb. 22, 2007

(54) Ink unit containing ink and ink-contacting member

(75) Inventor: Kiyoshi Morimoto, Ashigarakami-gun (JP)

Correspondence Address: BUCHANAN, INGERSOLL & ROONEY PC, POST OFFICE BOX 1404, ALEXANDRIA, VA, 22313-1404, US

(73) Assignee: Fuji Photo Film Co., Ltd.,, Minami-Ashigara-shi (JP)

(21) Appl. No.: 11/507,517

(22) Filed: Aug. 22, 2006

(30) Foreign Application Priority Data
Aug. 22, 2005 (JP) 2005-240011

(51) Int. Cl. G01D 11/00

(52) U.S. Cl. 347/100

(57) ABSTRACT

An ink unit comprising an ink for use in an ink jet recording apparatus; and a liquid-contacting member that contacts with the ink, wherein the ink comprises a phthalocyanine dye of a specific structure which has an oxidation potential of 1.0 V (vs SCE) or more, and wherein the major component of the ink-contacting member is a polyolefin containing [1] a specific hydrotalcite-like compound, [2] a fatty acid and/or fatty acid derivative, [3] a phenolic antioxidant having an isocyanurate skeleton or [4] an alkyl-substituted benzylidenesorbitol.

### BACKGROUND OF THE INVENTION

1. Field of the Invention

The present invention relates to an ink-contacting member such as an ink absorbing member, an ink tank and an ink jet cartridge for use in an ink jet recording apparatus equipped with an ink-ejecting recording head and to an ink.

2. Description of the Related Art

A so-called ink jet recording apparatus has been known which has a ink-ejecting type recording head wherein an ink-ejecting orifice is provided, and which allows the recording head to eject an ink as liquid droplets to deposit onto paper and record an image. In an ink jet recording apparatus is provided an ink tank, and an ink is fed from this ink tank to a recording head. As a material for a member which always comes into contact with an ink, there has been used a resin material, metallic material, rubber material or the like. Of these materials, a resin material has preferably been used from the viewpoint of cost and processability. Examples of the resin material include a polyolefin (e.g., polypropylene or polyethylene), polyvinyl chloride, polyvinylidene chloride, silicone, ethylene-vinyl acetate copolymer, ABS, polyacetal, nylon, unsaturated polyester, aramide, PS, PET and PVC. A polyolefin such as polypropylene or polyethylene has preferably been used from the viewpoint of easy recycling.

In some cases, an antioxidant is added to the resin material in order to prevent deterioration by oxidation which might be caused by heat, light or oxygen during the production steps or processing steps of the resin material or after processing the resin material. It has been known to add an oxidant (e.g., a phenol series antioxidant, an amine series antioxidant, a phosphorus-containing antioxidant or a thioether series antioxidant) in order to capture a radical to be generated in the initial chain growth step for automatic oxidation of the resin material.

Materials having a high crystallinity such as polyolefins (e.g., polypropylene and polyethylene) often provide moldings having non-uniform crystals and therefore scattering light and having insufficient transparency. It has been known to add bis(p-methylbenzylidene)sorbitol (trade name; GELOL MD) as a nucleating agent for crystallization for forming fine and uniform crystals.

In polymerization of an olefin for producing a polyolefin such as polypropylene or polyethylene, a catalyst such as the Ziegler-Natta catalyst is generally used, and so a catalyst residue such as a chlorine compound remains in a polymer formed. The catalyst residue remaining in the polymer has a possibility of corroding or deteriorating the polymer. For example, it may cause yellowing of the polymer. Therefore, it has been known to add a neutralizer to the resulting polymer for allowing the neutralizer to react with the catalyst residue to neutralize it. It has been known to add a metal salt of fatty acid such as calcium stearate or a hydrotalcite (basic aluminum magnesium carbonate) as the neutralizer.

As a neutralizer for polypropylene, it is generally conducted to add a metal salt of fatty acid such as calcium stearate in an amount of from 1,000 to 1,500 ppm. However, it has been known that, when used as an ink-contacting member, the metal salt of fatty acid can form a fibrous suspended matter which impede the flowability of the ink. For the purpose of preventing formation of the fibrous suspended matter, JP-A-63-216752 proposes a method of reducing the addition amount of the fatty acid derivative such as calcium stearate to 100 ppm or less.

Japanese Patent No. 2,696,828 describes a method of solving the problem of formation of a suspended matter caused by the solute from the ink-contacting member by a combination of a sodium ion concentration of the ink and the ink-contacting member. It has been found, however, that this method involves the problem of insufficient ink-ejecting accuracy after the ink has been in contact with the ink-contacting member for a long period of time.

### SUMMARY OF THE INVENTION

A subject of the present invention is to improve ink-ejecting accuracy after the ink has been in contact with an ink-contacting member (in the case where the main component of the member is a polyolefin) such as an ink tank, an ink jet cartridge and/or an ink absorbing member for a long time. That is, when an ink droplet impacts a position much distant from an original position intended to impact due to a large unevenness of the volume of an ejected ink, there result uneven density and uneven streak. Hence, the subject of the invention is to improve such ink jet quality.

The above-described subject has been solved by the following means.

[1] An ink unit comprising:

an ink for use in an ink jet recording apparatus; and

a liquid-contacting member that contacts with the ink,

wherein the ink comprises a phthalocyanine dye represented by formula (I) which has an oxidation potential of 1.0 V (vs SCE) or more, and

wherein a major component of the ink-contacting member is a polyolefin obtained by adding a hydrotalcite-like compound represented by formula (1):

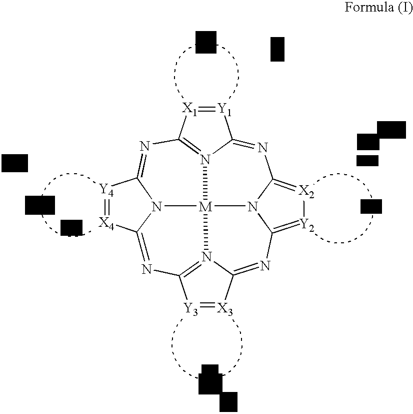

wherein X₁ to X₄ and Y₁ to Y₄ each independently represents a carbon atom or a nitrogen atom;

A₁ to A₄ each independently represents atoms necessary for forming an aromatic hydrocarbon ring or a hetero ring together with X₁ to X₄ and Y₁ to Y₄ and may further be condensed with other ring to form a condensed ring, provided that A₁ to A₄ may have a substituent, and at least one of A₁ to A₄ or at least one of substituents for A₁ to A₄ has a substituent capable of imparting solubility; and

M represents a hydrogen atom, a metal element, a metal oxide, a metal hydroxide or a metal halide:
[A₁₋ₓDₓ(OH)₂]^{x+}[E_{x/n}.mH₂O]^{x-} Formula (1)

wherein A represents a divalent metal;

D represents a trivalent metal;

E represents an n-valent anion;

m represents an integer; and

x satisfies relationship of 0<x≦0.5.

[2] The ink unit as described in [1] above,

wherein the hydrotalcite-like compound represented by formula (1) is a compound represented by formula of Mg₁₋ₓAlₓ(OH)₂(CO₃)_{x/2}.mH₂O, wherein x satisfies relationship of 0<x≦0.5.

[3] An ink unit comprising:

an ink for use in an ink jet recording apparatus; and

a liquid-contacting member that contacts with the ink,

wherein the ink comprises a phthalocyanine dye represented by formula (I) which has an oxidation potential of 1.0 V (vs SCE) or more, and

wherein a major component of the ink-contacting member is a polyolefin obtained by adding at least one of a fatty acid and a fatty acid derivative:

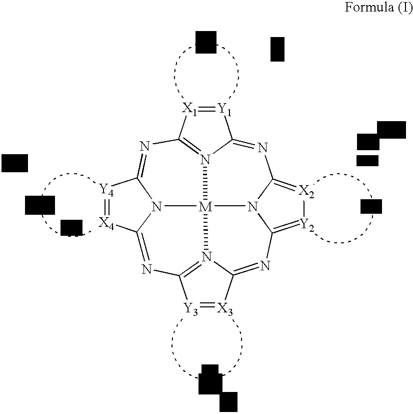

wherein X₁ to X₄ and Y₁ to Y₄ each independently represents a carbon atom or a nitrogen atom;

A₁ to A₄ each independently represents atoms necessary for forming an aromatic hydrocarbon ring or a hetero ring together with X₁ to X₄ and Y₁ to Y₄ and may further be condensed with other ring to form a condensed ring, provided that A₁ to A₄ may have a substituent, and at least one of A₁ to A₄ or at least one of substituents for A₁ to A₄ has a substituent capable of imparting solubility; and

M represents a hydrogen atom, a metal element, a metal oxide, a metal hydroxide or a metal halide.

[4] An ink unit comprising:

an ink for use in an ink jet recording apparatus; and

a liquid-contacting member that contacts with the ink,

wherein the ink comprises a phthalocyanine dye represented by formula (I) which has an oxidation potential of 1.0 V (vs SCE) or more, and

wherein a major component of the ink-contacting member is a polyolefin obtained by adding a phenol series antioxidant:

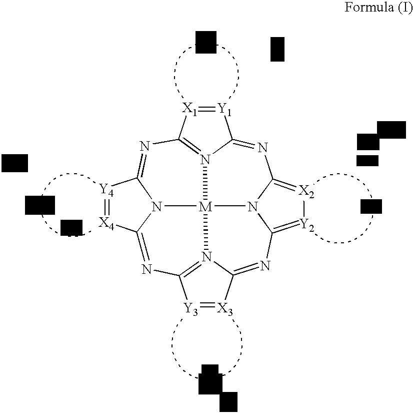

wherein X₁ to X₄ and Y₁ to Y₄ each independently represents a carbon atom or a nitrogen atom;

A₁ to A₄ each independently represents atoms necessary for forming an aromatic hydrocarbon ring or a hetero ring together with X₁ to X₄ and Y₁ to Y₄ and may further be condensed with other ring to form a condensed ring, provided that A₁ to A₄ may have a substituent, and at least one of A₁ to A₄ or at least one of substituents for A₁ to A₄ has a substituent capable of imparting solubility; and

M represents a hydrogen atom, a metal element, a metal oxide, a metal hydroxide or a metal halide.

[5] An ink unit comprising:

an ink for use in an ink jet recording apparatus; and

a liquid-contacting member that contacts with the ink,

wherein the ink comprises a phthalocyanine dye represented by formula (I) which has an oxidation potential of 1.0 V (vs SCE) or more, and

wherein a major component of the ink-contacting member is a polyolefin obtained by adding a benzylidenesorbitol:

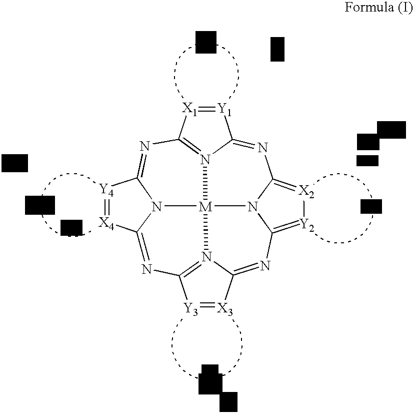

wherein X₁ to X₄ and Y₁ to Y₄ each independently represents a carbon atom or a nitrogen atom;

A₁ to A₄ each independently represents atoms necessary for forming an aromatic hydrocarbon ring or a hetero ring together with X₁ to X₄ and Y₁ to Y₄ and may further be condensed with other ring to form a condensed ring, provided that A₁ to A₄ may have a substituent, and at least one of A₁ to A₄ or at least one of substituents for A₁ to A₄ has a substituent capable of imparting solubility; and

M represents a hydrogen atom, a metal element, a metal oxide, a metal hydroxide or a metal halide.

[6] The ink unit as described in any of [1] to [5] above,

wherein the phthalocyanine dye is a dye represented by formula (II):

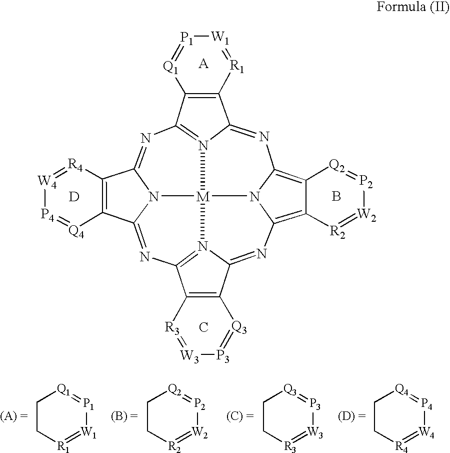

wherein Q₁ to Q₄ each independently represents ═C(J₁)- or —N═;

P₁ to P₄ each independently represents ═C(J₂)- or —N═;

W₁ to W₄ each independently represents ═C(J₃)- or —N═;

R₁ to R₄ each independently represents ═C(J₄)- or —N═;

J₁ to J₄ each independently represents a hydrogen atom or a substituent, provided that at least one of J₁ to J₄ is a substituent capable of imparting solubility or at least one of substituents which J₁ to J₄ have is a substituent capable of imparting solubility; and

M is the same as defined with respect to the formula (I).

[7] The ink unit as described in any of [1] to [6] above,

wherein the polyolefin is a polypropylene.

[8] The ink unit as described in any of [1] to [7] above,

wherein the ink-contacting member is an ink-contacting member of at least one of an ink tank and an ink jet cartridge.

[9] The ink unit as described in any of [1] to [7] above,

wherein the ink-contacting member is an ink-contacting member of an ink absorbing member.

[10] The ink unit as described in any of [1] to [7] above,

wherein the ink-contacting member is an ink-contacting member of at least one of a tube of ink-supplying system, a common path in a head, a pressure chamber in a head and a nozzle in a head.

### BRIEF DESCRIPTION OF THE DRAWINGS

FIG. 1 shows one example of a preferred ink jet recording apparatus of the invention; and

FIG. 2 shows a structural diagram of an ink cartridge to be used in FIG. 1.

### DETAILED DESCRIPTION OF THE INVENTION

As a result of intensive investigations to solve the above-mentioned problem, the inventor has found that unevenness in the volume of an ejected ink and, further, deviation of an ink droplet-impacted position from an original position intended to impact can be reduced by a combination of a specific ink-contacting member and a specific ink in the evaluation of ink ejection after bringing an ink into contact with an ink-contacting member used in the above-described ink jet recording apparatus for a long time or under a high temperature condition. Formation of no suspended matter was observed in the ink after contacting the ink with the ink-contacting member for a long time, and hence no problems were found by the visual evaluation of the ink. Superiority or inferiority in precision of ejection is interpreted as a phenomenon due to absence or presence of a precipitate in the meniscus in the vicinity of an ink-ejecting nozzle.

In order to attain the above-described object, [1] is an ink unit for use in an ink jet recording apparatus having a liquid-contacting member in contact with an ink, wherein the major component of the ink-contacting member is a polyolefin obtained by adding a hydrotalcite-like compound and the ink contains a specific phthalocyanine dye.

Also, [3] is characterized in that the ink-contacting member contains as a major component a polyolefin obtained by adding a fatty acid and/or a fatty acid derivative.

Also, [4] is characterized in that the ink-contacting member contains as a major component a polyolefin obtained by adding a phenol series antioxidant having an isocyanurate skeleton.

Also, [5] is characterized in that the ink-contacting member contains as a major component a polyolefin obtained by adding an alkyl-substituted benzylidenesorbitol.

Also, [6] is characterized in that the phthalocyanine dye has a further limited structure.

The term “ink-contacting member” as used in the invention means a member (ink-contacting member) with which an ink comes into contact while the ink stays in an ink-feeding system (e.g., an ink tank, tube, an ink cartridge or an ink-absorbing member) or within a head (e.g., a common flow path, a pressure chamber or a nozzle). The major component of the ink-contacting member is a polyolefin. The term “major component of the ink-contacting member” as used in the invention means a component which amounts to 50% (in surface area ratio, preferably ratio by mass) or more, preferably 70% or more, more preferably 95% or more, still more preferably 99% or more, based on the mass of the whole ink-contacting portion of the member. (In this specification, mass ratio is equal to weight ratio.)

The term “ink unit” as used in the invention means an assembly of an ink and an ink-contacting member in an ink-feeding system (including an ink tank, a tube, an ink cartridge and an ink-absorbing member) and a head interior (including a common flow path, a pressure chamber and a nozzle).

The polyolefin to be used in the invention means an olefin polymer, and examples thereof include polyethylene, polypropylene, polybutene, polystyrene and copolymers thereof. The polyolefin is preferably a polymer comprising ethylene and/or propylene. Polymers selected from among homo polypropylene (homo PP), ethylene-propylene random copolymer (random copolymer PP) and ethylene-propylene block copolymer (block copolymer PP) are preferred.

A hydrotalcite-like compound is added to a polyolefin of the invention.

The hydrotalcite-like compound is a non-stoichiometric compound represented by the following formula:
[A₁₋ₓDₓ(OH)₂]^{x+}[E_{x/n}.mH₂O]^{x-}
wherein A represents a divalent metal such as Mg, Mn, Fe, Co, Ni, Cu or Zn, D represents a trivalent metal such as Al, Fe, Cr, Co or In, E represents an n-valent anion such as OH, F, Cl, Br, NO₃, CO₃, SO₄, Fe(CN)₆ or CH₃COO, m represents an integer, and x satisfies the relationship of 0<x≦0.5.

To illustrate the hydrotalcite-like compound, there can be illustrated, for example, the following:
Mg₆Al₂(OH)₁₆.CO₃.4H₂O
Mg₄.5Al₂(OH)₁₃.CO₃.3.5H₂O
Ca₆Al₂(OH)₁₆.CO₃.4H₂O
Zn₆Al₂(OH)₁₆.CO₃.4H₂O
Mg₃ZnAl₂(OH)₁₂.CO₃.4H₂O

As the hydrotalcite-like compound to be used in the invention, those compounds can be used which are described in JP-A-6-100734, JP-A-6-256588, JP-A-10-87907, JP-A-10-139941 and JP-A-2001-316530.

A particularly preferred compound is a compound represented by the formula of Mg₁₋ₓAlₓ(OH)₂(CO₃)_{x/2}.mH₂O (0<x≦0.5).

A method for adding the hydrotalcite-like compound to a polyolefin resin is not particularly limited, and a known method may be employed. For example, there can be employed a method of dry-blending a resin powder or resin pellets with a powder of the additive or a method of preparing a master batch containing the additive in a high concentration and adding this to an additive-free resin. Also, there may be employed a continuously melt-kneading method wherein a hydrotalcite-like compound is added in a given amount and mixed in a popularly known mixer such as a Henschel mixer, a V blender or a tumbler type mixer, and the resulting mixture is introduced into a uniaxial kneader or a biaxial kneader of unidirectional rotary intermeshing type, bi-directional rotary intermeshing type, unidirectional rotary non-intermeshing type or bi-directional rotary non-intermeshing type or a batch-wise melt-kneading method using a roll mixer or a Bumbury mixer. A processing method of obtaining a molding from a polyolefin resin composition is not particularly limited, and any of common resin-molding methods such as an extrusion processing method, a calendar processing method, an injection molding method, a blow molding method and an inflation molding method may be employed.

The preferred addition amount of the hydrotalcite-like compound is in the range of from 10 ppm to 10,000 ppm, more preferably from 100 ppm to 1,000 ppm in the polyolefin.

A fatty acid and/or fatty acid derivative is added to a polyolefin of the invention. Specific examples of the fatty acid include stearic acid, k behenic acid, oleic acid and erucic acid. Specific examples of the fatty acid derivative include Ca, Al, Mg and Zn salts of stearic acid, stearic acid amide, Ca, Al, Mg and Zn salts of behenic acid, behenic amide, Ca, Al, Mg and Zn salts of oleic acid, oleic acid amide, Ca, Al, Mg and Zn salts of erucic acid and erucic amide. As other fatty acids and or fatty acid derivatives, those compounds may be used which are described in JP-A-2003-96246 as antacids or lubricants.

A method for adding the fatty acid and/or fatty acid derivative to a polyolefin resin is not particularly limited, and a known method may be employed. For example, there can be employed a method of dry-blending a resin powder or resin pellets with a powder of the additive or a method of preparing a master batch containing the additive in a high concentration and adding this to an additive-free resin. Also, there may be employed a continuously melt-kneading method wherein a fatty acid and/or fatty acid derivative is added in a given amount and mixed in a popularly known mixer such as a Henschel mixer, a V blender or a tumbler type mixer, and the resulting mixture is introduced into a uniaxial kneader or a biaxial kneader of unidirectional rotary intermeshing type, bi-directional rotary intermeshing type, unidirectional rotary non-intermeshing type or bi-directional rotary non-intermeshing type or a batch-wise melt-kneading method using a roll mixer or a Bumbury mixer. A processing method of obtaining a molding from a polyolefin resin composition is not particularly limited, and any of common resin-molding methods such as an extrusion processing method, a calendar processing method, an injection molding method, a blow molding method and an inflation molding method may be employed.

The preferred addition amount of the fatty acid and/fatty acid derivative is in the range of from 10 ppm to 1,000 ppm, more preferably from 50 ppm to 5000 ppm in the polyolefin.

A phenol series antioxidant is added to a polyolefin of the invention.

Specific examples of the phenol series antioxidant include tris(4-t-butyl-2,6-dimethyl-3-hydroxybenzyl)isocyanyrate, tris(3,5-di-t-butyl-4-hydroxybenzyl)isocyanurate, 2,6-di-t-butyl-4-methylphenol, 4-hydroxymethyl-2,6-di-t-butylphenol, 2,6-di-t-butyl-4-ethylphenolo, butyralted hydroxyanisole, n-octadecyl 3-(4-hydroxy-3,5-di-t-butylphenyl)propionate distearyl (4-hydroxy-3-methyl-5-t-butyl)benzylmalonate, propyl gallate, octyl gallate, dodecyl gallate, tocopherol, 2,2′-methylenebis(4-methyl-6-t-butylphenol), 2,2′-methylenebis(4-ethyl-6-t-butylphenol), 4,4′-methylenebis(2,6-di-t-butylphenol), 4,4′-butyrydenebis(6-t-butyl-m-cresol), 4,4′-thiobis(6-t-butyl-m-cresol), styrenated phenol, N,N′-hexamethylenebis(3,5-di-t-butyl-4-hydroxyhydrocinnamide), bis(ethyl 3,5-di-t-butyl-4-hydroxybenzylphosphonate) calcium, 1,1,3-tris(2-methyl-4-hydroxy-5-tert-butylphenyl)butane, 1,3,5-trimethyl-2,4,6-tris(3,5-di-t-butyl-4-hydroxybenzyl)benzene, tetrakis[3-(3,5-di-t-butyl-4-hydroxyphenyl)propionyloxymethyl]methane, 1,6-hexanediol-bis[3-(3,5-di-t-butyl-4-hydroxyphenyl)propionate], 2,2′-methylenebis(4-methyl-6-cyclohexylphenol), 2,2′-methylenebis[6-(1-methylcyclohexyl)-p-cresol], 1,3,5-tris(4-t-butyl-3-hydroxy-2,6-dimethylbenzyl)isocyanuric acid, 1,3,5-tris(3,5-di-t-butyl-4-hydroxybenzyl)isocyanuric acid, triethylene glycol bis[3-(3-t-butyl-4-hydroxy-5-methylphenyl)propionate], 2,2′-oxamidobis[ethyl 3-(3,5-di-t-butyl-4-hydroxyphenyl)propionate], 6-(4-hydroxy-3,5-di-t-butylanilino)-2,4-dioctylthio-1,3,5-triazine, bis[2-t-butyl-4-methyl-6-(2-hydroxy-3-t-butyl-5-methylbenzyl)phenyl]terephthalate, 3,9-bis[2-[3-(3-t-butyl-4-hydroxy-5-methylphenyl)propionyloxy]-1,1-dimethylethyl]2,4,8,10-tetraoxaspiro[5.5]undecane and 3,9-bis[2-[3-(3,5-di-t-butyl-4-hydroxyphenyl)propionyloxy]-1,1-dimethylethyl]2,4,8,10-tetraoxaspiro[5.5]undecane which, however, are not limitative at all.

Preferred examples of the phenol series antioxidant include tris(4-t-butyl-2,6-dimethyl-3-hydroxybenzyl)isocyanurate, tris(3,5-di-t-butyl-4-hydroxybenzyl)isocyanurate, 2,6-di-t-butyl-4-methylphenol, n-octadecyl 3-(4-hydroxy-3,5-di-t-butylphenyl)propionate, tetrakis[3-(3,5-di-t-butyl-4-hydroxyphenyl)propionyloxymethyl]methane, triethylene glycol bis[3-(3-t-butyl-4-hydroxy-5-methylphenyl)propionate], 4,4′-butyridenebis(6-t-butyl-m-cresol), 4,4′-thiobis(6-t-butyl-m-cresol), 1,3,5-tris(3,5-di-t-butyl-4-hydroxybenzyl)isocyanuric acid, 1,1,3-tris(2-methyl-4-hydroxy-5-t-butylphenyl)butane, and 3,9-bis[2-[3-(3-t-butyl-4-hydroxy-5-methylphenyl)propionyloxy]-1,1-dimethylethyl]-2,4,8,10-tetraoxaspiro[5.5]undecane.

As the phenol series antioxidant to be used in the invention, those compounds may be used which are described in JP-A-5-25330, JP-A-5-214176, JP-A-8-231779, JP-A-8-283473, JP-A-9-67474, JP-A-9-169875, JP-A-11-255973 and JP-A-2001-172438.

A method for adding the phenol series antioxidant to a polyolefin resin is not particularly limited, and a known method may be employed. For example, there can be employed a method of dry-blending a resin powder or resin pellets with a powder of the additive or a method of preparing a master batch containing the additive in a high concentration and adding this to an additive-free resin. Also, there may be employed a continuously melt-kneading method wherein a phenol series antioxidant is added in a given amount and mixed in a popularly known mixer such as a Henschel mixer, a V blender or a tumbler type mixer, and the resulting mixture is introduced into a uniaxial kneader or a biaxial kneader of unidirectional rotary intermeshing type, bi-directional rotary intermeshing type, unidirectional rotary non-intermeshing type or bi-directional rotary non-intermeshing type or a batch-wise melt-kneading method using a roll mixer or a Bumbury mixer. A processing method of obtaining a molding from a polyolefin resin composition is not particularly limited, and any of common resin-molding methods such as an extrusion processing method, a calendar processing method, an injection molding method, a blow molding method and an inflation molding method may be employed.

The preferred addition amount of the phenol series antioxidant is in the range of from 100 ppm to 10,000 ppm, more preferably from 500 ppm to 5000 ppm in the polyolefin.

A benzylidenesorbitol is added to a polyolefin of the invention.

Specific examples of the benzylidenesorbitol include 1,3:2,4-dibenzylidenesorbitol, 1,3:2,4-bis(p-methylbenzylidene)sorbitol, 1,3:2,4-(p-methylobenzylidene, benzylidene)sorbitol, 1,3:2,4-bis(3,4-dimethylbenzylidene)sorbitol, 1,3:2,4-(2,4-dimethylbenzylidene, benzylidene)sorbitol, 1,3:2,4-(2,5-dimethylbenzylidene, benzylidene)sorbitol, 1,3:2,4-bis(p-ethylbenzylidene)sorbitol, 1,3:2,4-bis(p-propylbenzylidene)sorbitol, 1,3:2,4-bis(p-butylbenzylidene)sorbitol, 1,3:2,4-bis(p-ethoxybenzylidene)sorbitol, 1,3:2,4-bis(p-butyoxybenzylidene)sorbitol, 1,3:2,4-bis(p-chlorobenzylidene)sorbitol and 1,3:2,4-bis(p-bromobenzylidene)sorbitol.

Particularly preferred examples thereof include 1,3:2,4-dibenzylidenesorbitol, 1,3:2,4-bis(p-methylbenzylydenesorbitol), 1,3:2,4-(p-mjethylbenzylidene, benzylidene)sorbitol, 1,3:2,4-bis(3,4-dimethylbenzylidene)sorbitol, 1,3:2,4-(2,4-dimethylbenzylidene, benzylidene)sorbitol, 1,3:2,4-(2,5-dimethylbenzylidene, benzylidene)sorbitol and 1,3:2,4-bis(p-ethylbenzylidene)sorbitol.

As the benzylidenesorbitol to be used in the invention, those compounds may be used which are described in JP-A-7-102123, JP-A-7-173342, JP-A-7-278362, JP-A-9-157452, JP-A-9-286787, JP-A-2001-26682, JP-A-2001-240698 and JP-A-2003-96246.

A method for adding the benzylidenesorbitol to a polyolefin resin is not particularly limited, and a known method may be employed. For example, there can be employed a method of dry-blending a resin powder or resin pellets with a powder of the additive or a method of preparing a master batch containing the additive in a high concentration and adding this to an additive-free resin. Also, there may be employed a continuously melt-kneading method wherein a benzylidenesorbitol is added in a given amount and mixed in a popularly known mixer such as a Henschel mixer, a V blender or a tumbler type mixer, and the resulting mixture is introduced into a uniaxial kneader or a biaxial kneader of unidirectional rotary intermeshing type, bi-directional rotary intermeshing type, unidirectional rotary non-intermeshing type or bi-directional rotary non-intermeshing type or a batch-wise melt-kneading method using a roll mixer or a Bumbury mixer. A processing method of obtaining a molding from a polyolefin resin composition is not particularly limited, and any of common resin-molding methods such as an extrusion processing method, a calendar processing method, an injection molding method, a blow molding method and an inflation molding method may be employed.

The preferred addition amount of the sorbitol derivative is in the range of from 100 ppm to 10,000 ppm, more preferably from 500 ppm to 5000 ppm in the polyolefin.

The phthalocyanine dye to be used in the invention is represented by the following formula (I): 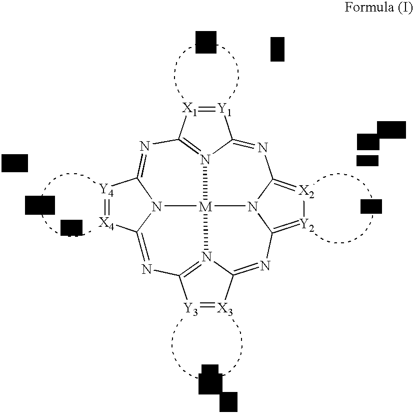
wherein X₁ to X₄ and Y₁ to Y₄ each independently represents a carbon atom or a nitrogen atom, preferably a carbon atom, A₁ to A₄ each independently represents atoms necessary for forming an aromatic hydrocarbon ring or a hetero ring together with X₁ to X₄ and Y₁ to Y₄ (and may further be condensed with other ring to form a condensed ring), A₁ to A₄ may have a substituent, at least one of A₁ to A₄ or at least one of substituents for A₁ to A₄ has a substituent capable of imparting solubility (in the case where the dye is water-soluble, the substituent is an ionic hydrophilic group and, in the case where the dye is oil-soluble, the substituent is a hydrophobic group), and M represents a hydrogen atom, a metal element, a metal oxide, a metal hydroxide or a metal halide.

Of the phthalocyanine dyes represented by the formula (I), phthalocyanine dyes of the structure represented by the following formula (II) are more preferred.

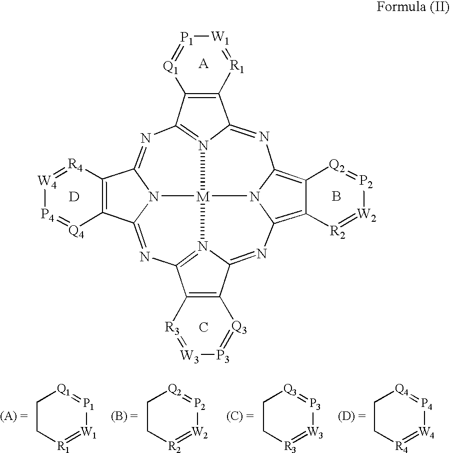

In the formula (II), Q₁ to Q₄ each independently represents ═C(J₁)- or —N═, P₁ to P₄ each independently represents ═C(J₂)- or —N═, W₁ to W₄ each independently represents ═C(J₃)- or —N═, R₁ to R₄ each independently represents ═C(J₄)- or —N═, J₁ to J₄ each independently represents a hydrogen atom or a substituent. It is preferred that at least one, still more preferably two or more, of the 4 rings {ring A: (A); ring B: (B); ring C: (C); and ring D: (D)} comprising (Q₁, P₁, W₁, R₁), (Q₂, P₂, W₂, R₂), (Q₃, P₃, W₃, R₃) and (Q₄, P₄, W₄, R₄), respectively, represent aromatic hydrocarbon rings. In the case where any of ring A, ring B, ring C and ring D represents a hetero ring, such hetero ring is preferably a pyridine ring or a pyrazine ring.

In the case where J₁ to J₄ represents a substituent, such substituent is preferably an electron attractive substituent and, further, at least one of J1 to J4 is a substituent capable of imparting solubility (in the case where the dye is water soluble, such substituent is an ionic hydrophilic group and, in the case where the dye is oil-soluble, such substituent is a hydrophobic group) or at least one of substituents which J₁ to J₄ have is a substituent capable of imparting solubility (in the case where the dye is water soluble, such substituent is an ionic hydrophilic group and, in the case where the dye is oil-soluble, such substituent is a hydrophobic group), and M is the same as defined with respect to the formula (I).

In the case where any ring of ring A, ring B, ring C and ring D in the formula (II) is an aromatic hydrocarbon ring, such hydrocarbon ring is preferably a ring represented by the following formula (III).

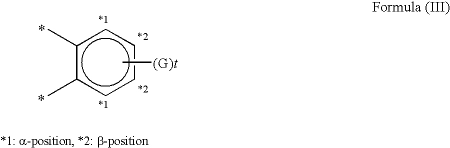

In the formula (III), * represents the position at which the ring connects to form a phthalocyanine skeleton. In this specification, a position nearer to * is referred to as “α-position” and a position farther from * is referred to as “β-position”. The formula (III) shows that substitution position of G is not specified to either of α- and β-positions. G preferably represents —SO-Z, —SO₂-Z, —SO₂NV₁V₂, —CONV₁V₂, —CO₂Z, —COZ or sulfo group. t represents an integer of from 1 to 4. With the formula (III), preferred are those wherein G represents —SO-Z, —SO₂Z, —SO₂NV₁V₂, —CONV₁V₂, —CO₂Z or sulfo group, particularly preferred are those wherein G represents —SO-Z, —SO₂-Z or —SO₂NV₁V₂, most preferred are those wherein G represents —SO₂-Z. t preferably represents 1 or 2, with 1 being most preferred.

Z may be the same or different, and represents a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group or a substituted or unsubstituted hetero ring group, preferably a substituted or unsubstituted alkyl group, a substituted or unsubstituted aryl group or a substituted or unsubstituted hetero ring group. Of these, a substituted alkyl group, a substituted aryl group or a substituted hetero ring group is most preferred.

V₁ and V₂ may be the same or different, and each represents a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group or a substituted or unsubstituted hetero ring group, preferably a hydrogen atom, a substituted or unsubstituted alkyl group, a substituted or unsubstituted aryl group or a substituted or unsubstituted hetero ring group. Of these, a hydrogen atom, a substituted alkyl group, a substituted aryl group or a substituted hetero ring group is most preferred.

In the case where any of ring A, ring B, ring C and ring D in the formula (II) is an aromatic hydrocarbon ring, it is particularly preferred that at least one such aromatic ring is represented by the following formula (IV). The formula (IV) shows that substitution position of G is β-position.

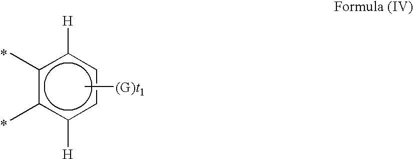

In the formula (IV), * represents the position at which the ring connects to form a phthalocyanine skeleton. G is the same as defined with respect to the formula (III), preferred ones, particularly preferred ones and most preferred ones are also the same as described there. t1 represents 1 or 2, with 1 being most preferred. Particularly preferably, all aromatic hydrocarbon rings are those which are represented by the formula (IV).

Of the phthalocyanine dyes, particularly preferred are phthalocyanine dyes of the general formula (V).

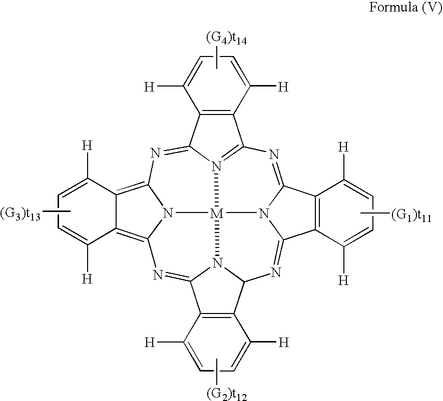

In the formula (V), G₁ to G₄ are the same as defined with G in the formula (III), and preferred ones, particularly preferred ones and most preferred ones are also the same as described there. M is the same as defined with M in the formula (I). t11 to t14 each represents 1 or 2, with 1 being most preferred.

Additionally, as described in JP-A-2003-213168 (chiral carbon-containing Pc), phthalocyanine dyes are in most cases not a single structure compound but a mixture of compounds having different chemical structures derived from the synthesizing process except for the case where a phthalonitrile derivative wherein substituents on the benzene rings are in a relation of linear symmetry is used as a starting material for preparing a phthalocyanine dye. In the invention, “phthalocyanine dyes” include both a single structure dye and a mixture dye.

Here, substituents having been described with respect to the formulae (I) to (V) will be described in more detail below.

Examples of the substituents which the formula (I) may have include a halogen atom, an alkyl group, a cycloalkyl group, an alkenyl group, an alkynyl group, an aralkyl group, an aryl group, a hetero ring group, a cyano group, a hydroxyl group, a nitro group, an amino group, an alkylamino group, an arylamino group, an alkoxy group, an aryloxy group, an acylamino group, a ureido group, a sulfamoylamino group, an alkylthio group, an arylthio group, an alkoxycarbonylamino group, a sulfonamido group, a carbamoyl group, a sulfamoyl group, a sulfonyl group, a sulfinyl group, an alkoxycarbonyl group, a hetero ring oxy group, an azo group, an acyloxy group, a carbamoyloxy group, a silyloxy group, an aryloxycarbonyl group, an aryloxycarbonylamino group, an imido group, a hetero ring thio group, a phosphoryl group, an acyl group, a carboxyl group, a phosphono group, a quaternary ammonium group and a sulfo group.

In the formula (II), as J₁ to J₄, the above-described substituents may be illustrated. Among them, a halogen atom, a hetero ring group, a cyano group, a carboxyl group, a sulfonamido group, a sulfamoyl group, a carbamoyl group, an alkoxycarbonyl group, a sulfonyl group, a sulfinyl group, an imido group, an acyl group, a sulfo group and a quaternary ammonium group are preferred electron attractive groups.

As a substituted or unsubstituted alkyl group represented by Z, V₁ or V₂ in the formulae (III) to (V), an alkyl group containing from 1 to 30 carbon atoms is preferred. In view of enhancing solubility of the dye or ink stability, a branched alkyl group is preferred, with a branched alkyl group having a chiral carbon or carbons (to be used as a racemate) being particularly preferred. As examples of the substituent, there can be illustrated those substituents which the formula (I) may have. Of those, a hydroxyl group, an ether group, an ester group, a cyano group, an amino group (which may further have a substituent such as an amino group substituted by a substituted hetero ring group), an amido group and a sulfonamido group are particularly preferred, because these enhance associating properties of the dye and improve fastness.

Besides, they may have a halogen atom or an ionic hydrophilic group.

As a substituted or unsubstituted cycloalkyl group represented by Z, V₁ or V₂, a cycloalkyl group containing from 5 to 30 carbon atoms is preferred. In view of enhancing solubility of the dye or ink stability, a cycloalkyl group having a chiral carbon or carbons (to be used as a racemate) is particularly preferred. As examples of the substituent, there can be illustrated those substituents which the formula (I) may have. Of those, a hydroxyl group, an ether group, an ester group, a cyano group, an amino group, an amido group and a sulfonamido group are particularly preferred, because these enhance associating properties of the dye and improve fastness. Besides, they may have a halogen atom or an ionic hydrophilic group.

As a substituted or unsubstituted alkenyl group represented by Z, V₁ or V₂, an alkenyl group containing from 2 to 30 carbon atoms is preferred. In view of enhancing solubility of the dye or ink stability, a branched alkenyl group is preferred, with a branched alkenyl group having a chiral carbon or carbons (to be used as a racemate) being particularly preferred. As examples of the substituent, there can be illustrated those substituents which the formula (I) may have. Of those, a hydroxyl group, an ether group, an ester group, a cyano group, an amino group, an amido group and a sulfonamido group are particularly preferred, because these enhance associating properties of the dye and improve fastness.

Besides, they may have a halogen atom or an ionic hydrophilic group.

As a substituted or unsubstituted alkynyl group represented by Z, V₁ or V₂, an alkynyl group containing from 2 to 30 carbon atoms is preferred. In view of enhancing solubility of the dye or ink stability, a branched alkynyl group is preferred, with a branched alkynyl group having a chiral carbon or carbons (to be used as a racemate) being particularly preferred. As examples of the substituent, there can be illustrated those substituents which the formula (I) may have. Of those, a hydroxyl group, an ether group, an ester group, a cyano group, an amino group, an amido group and a sulfonamido group are particularly preferred, because these enhance associating properties of the dye and improve fastness.

Besides, they may have a halogen atom or an ionic hydrophilic group.

As a substituted or unsubstituted aralkyl group represented by Z, V₁ or V₂, an aralkyl group containing from 7 to 30 carbon atoms is preferred. In view of enhancing solubility of the dye or ink stability, a branched aralkyl group is preferred, with an aralkyl group having a chiral carbon or carbons (to be used as a racemate) being particularly preferred. As examples of the substituent, there can be illustrated those substituents which the formula (I) may have. Of those, a hydroxyl group, an ether group, an ester group, a cyano group, an amino group, an amido group and a sulfonamido group are particularly preferred, because these enhance associating properties of the dye and improve fastness. Besides, they may have a halogen atom or an ionic hydrophilic group.

As a substituted or unsubstituted aryl group represented by Z, V₁ or V₂, an aryl group containing from 6 to 30 carbon atoms is preferred. As examples of the substituent, there can be illustrated those substituents which the formula (I) may have. Of those, an electron attractive group is particularly preferred, because it renders the oxidation potential of the dye noble and enhances associating properties of the dye and improves fastness.

As a hetero ring group represented by Z, V₁ or V₂, a 5- or 6-membered hetero ring is preferred, which may further be condensed with other ring. The hetero ring may be an aromatic hetero ring or a non-aromatic hetero ring. The hetero ring represented by Z, V₁ or V₂ is exemplified below as a hetero ring with omitting the substitution position. The substitution position is not particularly limited. For example, with pyridine, it can substitute at a 2-, 3- or 4-position thereof. there are illustrated pyridine, pyrazine, pyrimidine, pyridazine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, benzoxazole, thiazole, benzothiazole, isothiazole, benzisothiazole, thiadiazole, isoxazole, benzisoxazole, pyrrolidine, piperidine, piperazine, imidazolidine and thiazoline.

Among them, aromatic hetero ring groups are preferred. To illustrate preferred examples thereof as above, there are illustrated pyridine, pyrazine, pyrimidine, pyridazine, triazine, pyrazole, imidazole, benzimidazole, triazole, thiazole, benzothiazole, isothiazole, benzoisothiazole and thiadiazole. These may have a substituent and, as examples of such substituent, there are illustrated those substituents which the formula (I) may have. Preferred substituents are the same as those substituents for the foregoing aryl group, and more preferred substituents are the same as more preferred substituents for the foregoing aryl group.

In the case where phthalocyanine dyes of the invention are water-soluble, they have an ionic hydrophilic group. Examples of the ionic hydrophilic group include a sulfo group, a carboxyl group, a phosphono group and a quaternary ammonium group. As the ionic hydrophilic group, a carboxyl group, a phosphono group and a sulfo group are preferred, with a carboxyl group and a sulfo group being particularly preferred. A carboxyl group, a phosphono group and a sulfo group may be in a salt form, and examples of counter ion forming the salt include an ammonium ion, an alkali metal ion (e.g., lithium ion, sodium ion or potassium ion) and an organic cation (e.g., tetramethylammonium ion, tetramethylguanidium ion or tetramethylphosphonium ion). Of the counter ion, an alkali metal ion is preferred, with lithium ion being more preferred because it enhances solubility of the dye and improves ink stability. As to the number of the ionic hydrophilic group, phthalocyanine dyes of the invention have preferably at least two ionic hydrophilic groups per molecule, and phthalocyanine dyes having at least two sulfo groups and/or carboxyl groups are particularly preferred.

In the case where phthalocyanine dyes are oil-soluble, they preferably have a hydrophobic group. Preferred examples of the hydrophobic group include an aliphatic group containing 4 or more carbon atoms (e.g., an alkyl group, a cycloalkyl group, an alkenyl group or an alkynyl group), an aryl group containing 6 or more carbon atoms, an alkoxy group, an aryloxy group, an acylamino group, an alkylthio group, an arylthio group, an alkoxycarbonylamino group, a sulfonamido group, a carbamoyl group, a sulfamoyl group, a sulfonyl group, an alkoxycarbonyl group, an acyloxy group, an amino group (including an aniline group) and an acyl group.

M represents a hydrogen atom, a metal element or its oxide, hydroxide or halide.

Preferred examples of M include a hydrogen atom and metal atoms of Li, Na, K, Mg, Ti, Zr, V, Nb, Ta, Cr, Mo, W, Mn, Fe, Co, Ni, Ru, Rh, Pd, Os, Ir, Pt, Cu, Ag, Au, Zn, Cd, Hg, Al, Ga, In, Si, Ge, Sn, Pb, Sb and Bi. Oxides include VO and GeO. Hydroxides include Si(OH)₂, Cr(OH)₂ and Sn(OH)₂. Further, halides include AlCl, SiCl₂, VCl, VCl₂, VOCl, FeCl, GaCl and ZrCl.

Of these, Cu, Ni, Zn and Al are particularly preferred, with Cu being most preferred.

Also, Pcs (phthalocyanine rings) may be connected to each other through L (divalent linking group) to form a dimmer (e.g., Pc-M-L-M-Pc) or a trimer wherein M may be the same or different.

As the divalent linking group represented by L, an oxy group (—O—), a thio group (—S—), a carbonyl group (—CO—), a sulfonyl group (—SO₂—), an imino group (—NH—), a methylene group (—CH₂—) and a group formed by combining these are preferred

With respect to combination of preferred substituents in the compounds represented by the foregoing formulae (I), (II) and (V), a compound wherein at least one of the various substituents is the aforesaid preferred group is preferred, a compound wherein more of the various substituents are the aforesaid preferred groups are more preferred, and a compound wherein all substituents are the aforesaid preferred groups are most preferred.

As a chemical structure of the phthalocyanine dye of the invention, it is preferred to introduce at least one electron attractive group such as a sulfinyl group, a sulfonyl group or a sulfamoyl group into each benzene ring of phthalocyanine of the invention to adjust sum of the σp values of the whole substituents of the entire phthalocyanine skeletone to 1.2 or more.

The σp value, Hammett's substituent constant, will be described to some extent below. The Hammett's rule is an empirically found rule which was proposed by L. P. Hammett in year 1935 in order to quantitatively discus influence of a substituent on a reaction of a benzene derivative or equilibrium thereof, and its appropriateness is at present widely accepted. The substituent constant to be determined by the Hamett's rule includes the σp value and the σm value. These values can be found many general books, and are described in detail in, for example, Lange's Handbook of Chemistry compiled by J. A. Dean, 12^{th} ed., 1979 (Mc Grawo-Hill) and Kagaku no Ryoiki, Zokan, No. 122, pp. 96-103, 1979 (Nankodo).

In the invention, of the phthalocyanine dyes represented by the foregoing formulae (I), (II) and (V), water-soluble dyes having an ionic hydrophilic group are more preferred than oil-soluble dyes.

Specific examples of the phthalocyanine dyes represented by the foregoing formulae (I), (II) and (V) are shown below which, however, do not limit the phthalocyanine dyes to be used in the invention.

TABLE 1
In Table 1, with specific examples of combinations (X₁, X₂), (Y₁₁, Y₁₂), (Y₁₃, Y₁₄),
(Y₁₅, Y₁₆) and (Y₁₇, Y₁₈), the orders are not special.

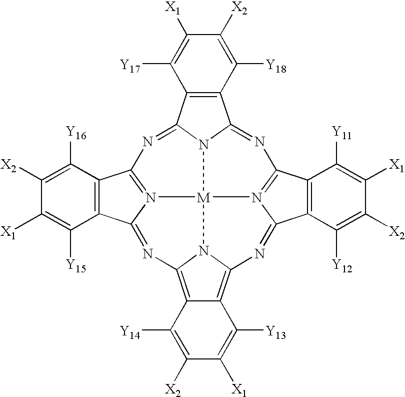

| Compound | M | X₁ | X₂ | Y₁₁, Y₁₂ | Y₁₃, Y₁₄ | Y₁₅, Y₁₆ | Y₁₇, Y₁₈ |
|---|---|---|---|---|---|---|---|
| 101 | Cu | —SO₂—NH—CH₂—CH₂—SO₃ₜMt | —H | —H, —H | —H, —H | —H, —H | —H, —H |
| 102 | Cu | 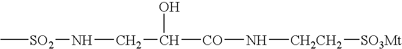 | —H | —Cl, —H | —Cl, —H | —Cl, —H | —Cl, —H |
| 103 | Cu | 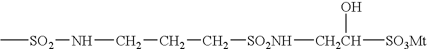 | —H | —H, —H | —H, —H | —H, —H | —H, —H |
| 104 | Cu | 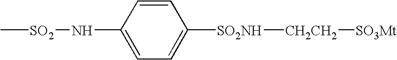 | —H | —H, —H | —H, —H | —H, —H | —H, —H |
| 105 | Ni | 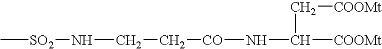 | —H | —Cl, —H | —Cl, —H | —Cl, +113 H | —Cl, —H |
| 106 | Cu | —SO₂—NH—CH₂—CH₂—SO₂—NH—CH₂—COOMt | —CN | —H, —H | —H, —H | —H, —H | —H, —H |
| 107 | Cu | 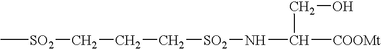 | —H | —H, —H | —H, —H | —H, —H | —H, —H |
| 108 | Cu | —SO₂—CH₂—CH₂—CH₂—SO₃Mt | —H | —H, —H | —H, —H | —H, —H | —H, —H |
| 109 | Cu | —SO₂—CH₂—CH₂—CH₂—SO₃Mt | —H | —H, —H | —H, —H | —H, —H | —H, —H |
| 110 | Cu | —SO₂—(CH₂)₅—CO₂Mt | —H | —H, —H | —H, —H | —H, —H | —H, —H |

TABLE 2
In Table 2, with specific examples of combinations (X₁, X₂), (Y₁₁, Y₁₂), (Y₁₃, Y₁₄),
(Y₁₅, Y₁₆) and (Y₁₇, Y₁₈), the orders are not special.

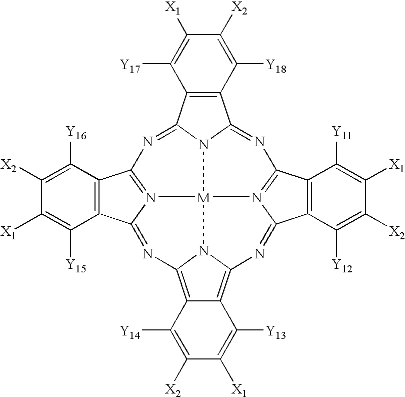

| Com- | | | | | | | |
|---|---|---|---|---|---|---|---|
| pound | | | | | | | |
| No. | M | X₁ | X₂ | Y₁₁, Y₁₂ | Y₁₃, Y₁₄ | Y₁₅, Y₁₆ | Y₁₇, Y₁₈ |
| 111 | Cu | 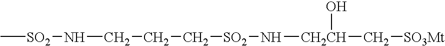 | —H | —H, —H | —H, —H | —H, —H | —H, —H |
| 112 | Cu | 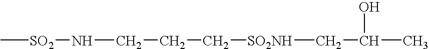 | —SO₃Li | —H, —H | —H, —H | —H, —H | —H, —H |
| 113 | Cu | 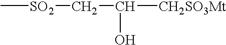 | —H | —H, —H | —H, —H | —H, —H | —H, —H |
| 114 | Cu | 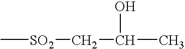 | —SO₃Li | —H, —H | —H, —H | —H, —H | —H, —H |
| 115 | 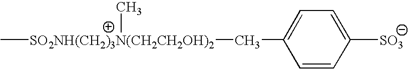 | —H | —H, —H | —H, —H | —H, —H | —H, —H | |
| 116 | Cu | 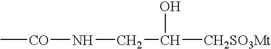 | —H | —H, —H | —H, —H | —H, —H | —H, —H |
| 117 | Cu | 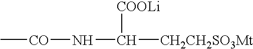 | +113 H | —H, —H | —H, —H | —H, —H | —H, —H |

TABLE 3
In Table 3, with specific examples of combinations (X₁, X₂), (Y₁₁, Y₁₂), (Y₁₃, Y₁₄),
(Y₁₅, ZY₁₆) and (Y₁₇, Y₁₈), the orders are not special.

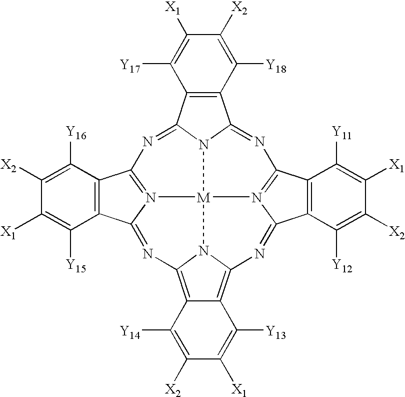

| Compound No. | M | X₁ | X₂ | Y₁₁, Y₁₂ | Y₁₃, Y₁₄ | Y₁₅, Y₁₆ | Y₁₇, Y₁₈ |
|---|---|---|---|---|---|---|---|
| 118 | Cu | 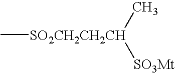 | —H | —H, —H | —H, —H | —H, —H | —H, —H |
| 119 | Cu | 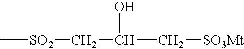 | —H | —H, —H | —H, —H | —H, —H | —H, —H |
| 120 | Cu | 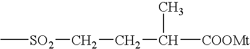 | —H | —H, —H | —H, —H | —H, —H | —H, —H |
| 121 | Cu | 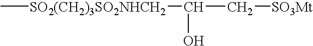 | —H | —H, —H | —H, —H | —H, —H | —H, —H |
| 122 | Cu | 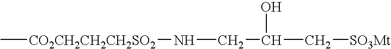 | —H | —H, —H | —H, —H | —H, —H | —H, —H |
| 123 | Cu | —SO₂NH—C₈H₁₇(t) | —H | —H, —H | —H, —H | —H, —H | —H, —H |
| 124 | Cu | 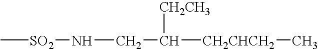 | —H | —H, —H | —H, —H | —H, —H | —H, —H |

TABLE 4
In Table 4, with specific examples of combinations (X₁, X₂), (Y₁₁, Y₁₂), (Y₁₃, Y₁₄),
(Y₁₅, Y₁₆) and (Y₁₇, Y₁₈), the orders are not special.

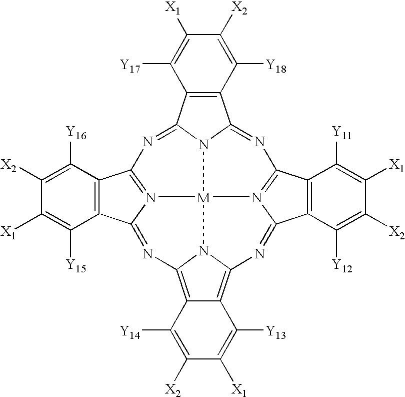

| Compound No. | M | X₁ | X₂ | Y₁₁, Y₁₂ | Y₁₃, Y₁₄ | Y₁₅, Y₁₆ | Y₁₇, Y₁₈ |
|---|---|---|---|---|---|---|---|
| 125 | Cu | 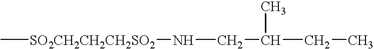 | —H | —H, —H | —H, —H | —H, —H | —H, —H |
| 126 | Cu | 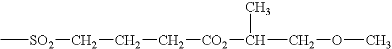 | —H | —H, —H | —H, —H | —H, —H | —H, —H |
| 127 | Cu | 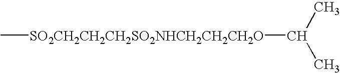 | —H | —H, —H | —H, —H | —H, —H | —H, —H |
| 128 | Zn | 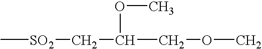 | —CN | —H, —H | —H, —H | —H, —H | —H, —H |
| 129 | Cu | 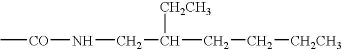 | —H | —Cl, —H | —Cl, —H | —Cl, —H | —Cl, —H |
| 130 | Cu | 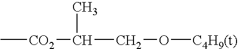 | —H | —H, —H | —H, —H | —H, —H | —H, —H |
| 131 | Cu | 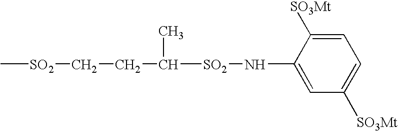 | —H | —H, —H | —H, —H | —H, —H | —H, —H |

TABLE 5
In Table 5, with specific examples of combinations (X₁, X₂), (Y₁₁, Y₁₂), (Y₁₃, Y₁₄),

(Y₁₅, Y₁₆) and (Y₁₇ , Y₁₈ ), the orders are not special.

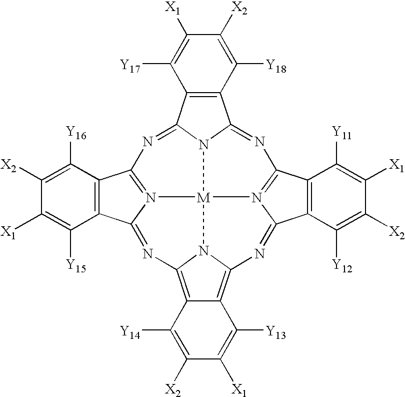

| Compound No. | M | X₁ | X₂ | Y₁₁, Y₁₂ | Y₁₃, Y₁₄ | Y₁₅, Y₁₆ | Y₁₇,Y₁₈ |
|---|---|---|---|---|---|---|---|
| 132 | Cu | 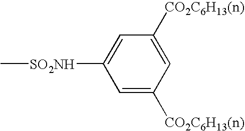 | —H | —H, —H | —H, —H | —H, —H | —H, —H |
| 133 | Cu | 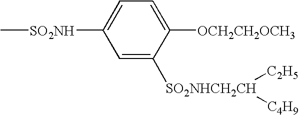 | —H | —H, —H | —H, —H | —H, —H | —H, —H |
| 134 | Cu | 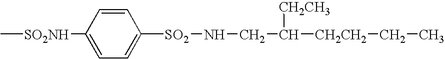 | —H | —H, —H | —H, —H | —H, —H | —H, —H |
| 135 | Cu | 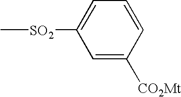 | —H | —H, —H | —H, —H | —H, —H | —H, —H |
| 136 | Cu | 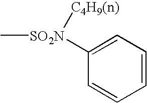 | —H | —H, —H | —H, —H | —H, —H | —H, —H |

TABLE 6
In Table 6, with specific examples of combinations (X₁,X₂), (Y₁₁,Y₁₂), (Y₁₃,Y₁₄),
(Y₁₅,Y₁₆) and (Y₁₇,Y₁₈), the orders are not special.

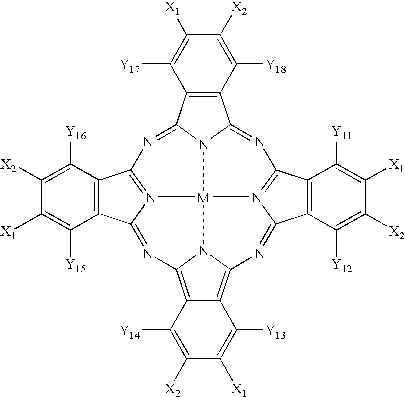

| | | | | Y₁₁, | | Y₁₅, | |
|---|---|---|---|---|---|---|---|
| Compound No. | M | X₁ | X₂ | Y₁₂ | Y₁₃, Y₁₄ | Y₁₆ | Y₁₇, Y₁₈ |
| 137 | Cu | 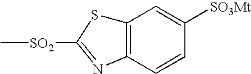 | —H | —H, —H | —H, —H | —H, —H | —H, —H |
| 138 | Cu | 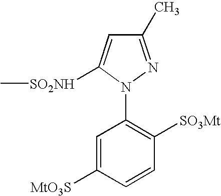 | —H | —H, —H | —H, —H | —H, —H | —H, —H |
| 139 | Cu | 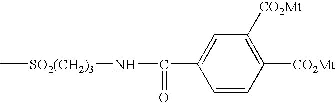 | —Cl | —H, —H | —H, —H | —H, —H | —H, —H |
| 140 | Cu | 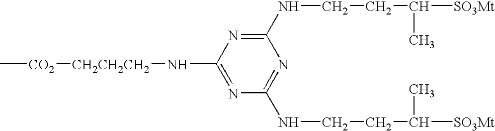 | —H | —H, —H | —H, —H | —H, —H | —H, —H |

TABLE 7
In Table 7, with specific examples of combinations (X₁, X₂), (Y₁₁, Y₁₂), (Y₁₃, Y₁₄),
(Y₁₅, Y₁₆) and (Y₁₇, Y₁₈), the orders are not special.

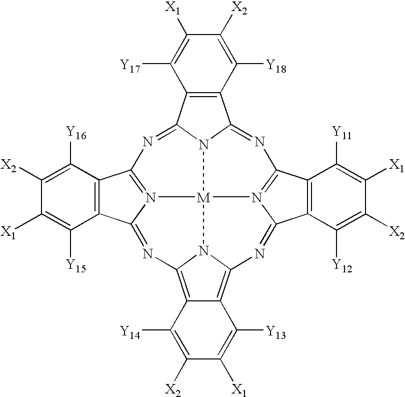

| Compound | | | | Y₁₁, | Y₁₃, | Y₁₅, | Y₁₇, |
|---|---|---|---|---|---|---|---|
| No. | M | X₁ | X₂ | Y₁₂ | Y₁₄ | Y₁₆ | Y₁₈ |
| 141 | Cu | 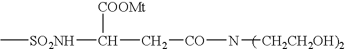 | —H | —H, —H | —H, —H | —H, —H | —H, —H |
| 142 | Cu | 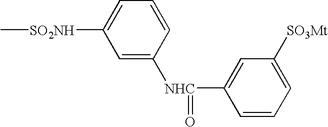 | —H | —H, —H | —H, —H | —H, —H | —H, —H |
| 143 | Cu | 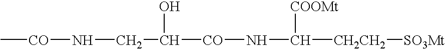 | —H | —H, —H | —H, —H | —H, —H | —H, —H |
| 144 | Cu | 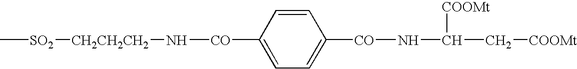 | —H | —H, —H | —H, —H | —H, —H | —H, —H |
| 145 | Cu | 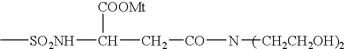 | —H | —H, —H | —H, —H | —H, —H | —H, —H |

TABLE 8

| Compound No. | M | R₁ | m | R₂ | n |
|---|---|---|---|---|---|
| 146 | Cu | 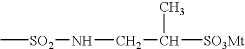 | 3 | 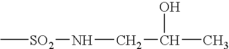 | 1 |
| 147 | Cu | —SO₂—NH—CH₂—CH₂SO₂Mt | 3 | 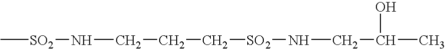 | 1 |
| 148 | Cu | 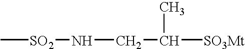 | 3 | —SO₂NH—CH₂—CH₂—CH₂—SO₂—NH—CH₂—CH₂—O—CH₂—CH₂—OH | 1 |
| 149 | Cu | 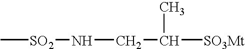 | 2 | —SO₂—NH—CH₂—CH₂—CH₂—CO—N [symbol] CH₂—CH₂—OH)₂ | 2 |
| 150 | Cu | —SO₂—NH—CH₂—CH₂—SO₂—NH—CH₂CH₂—COOMt | 3 | 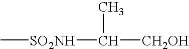 | 1 |
| 151 | Cu | 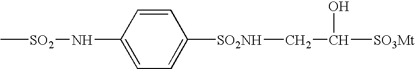 | 3 | —SO₂NH—CH₂—CH₂—O—CH₂—CH₂—OH | 1 |
| 152 | Cu | 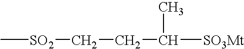 | 2.5 | —SO₂—CH₂—CH₂—O—CH₂—CH₂—OH | 1.5 |
| 153 | Cu | 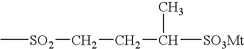 | 2 | —SO₂—CH₂—CH₂—CH₂—CO—N [symbol] CH₂—CH₂13 OH)₂ | 2 |
| 154 | Cu | —SO₂—CH₂—CH₂—CH₂—SO₃Mt | 3 | 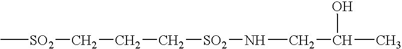 | 1 |
| 155 | Cu | —SO₂—CH₂—CH₂—CH₂—COOMt | 2 | 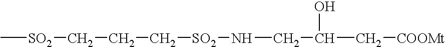 | 2 |
| 156 | Cu | —SO₂—CH₂—CH₂—CH₂—SO₃Mt | 3 | 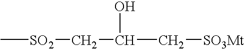 | 1 |
| 157 | Cu | —SO₂—CH₂—CH₂—O—CH₂—CH₂—SO₃Mt | 2 | 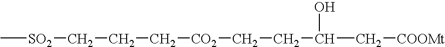 | 2 |

TABLE 9

| Compound No. | M | R₁ | m | R₂ | n |
|---|---|---|---|---|---|
| 158 | Cu | 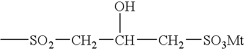 | 3 | 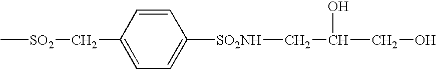 | 1 |
| 159 | Cu | —SO₂NHCH₂CH₂—SO₂Mt | 3 | 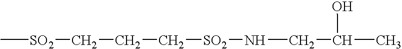 | 1 |
| 160 | Cu | —SO₂—CH₂—CH₂—O—CH₂—CH₂—O—CH₂—CH₂—SO₃Mt | 3 | 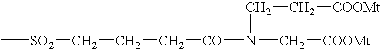 | 1 |
| 161 | Cu | —SO₂CH₂CH₂CH₂SO₃Mt | 3 | 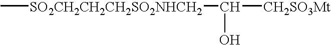 | 1 |
| 162 | Cu | —SO₂CH₂CH₂CH₂SO₃Mt | 2 | —SO₂CH₂CH₂OCH₂CH₂OH | 2 |
| 163 | Cu | —SO₂CH₂CH₂CH₂SO₃Mt | 3 | 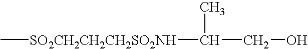 | 1 |
| 164 | Cu | —SO₂CH₂CH₂CH₂SO₃Mt | 2 | —SO₂CH₂CH₂CH₂SO₂N(CH₂CH₂OH)₂ | 2 |
| 165 | Cu | —CO—NH—CH₂—CH₂—SO₃Mt | 3 | —CO—NH—CH₂—CH₂—O—CH₂CH₂—OH | 1 |
| 166 | Cu | —CO—NH—CH₂—CH₂—SO₂—NH—CH₂—CH₂—COOMt | 3 | 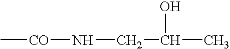 | 1 |
| 167 | Cu | 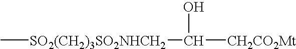 | 2.5 | —CO—NH—CH₂—CH₂CH₂CO—N [symbol] CH₂—CH₂—OH)HD 2 | 1.5 |
| 168 | Cu | 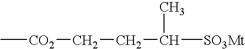 | 2 | —CO—CH₂—CH₂—CH₂—CO—N [symbol] CH₂—CH₂OH)₂ | 2 |
| 169 | Cu | —CO₂—CH₂—CH₂—CH₂—SO₃Mt | 3 | 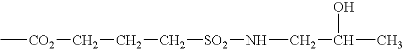 | 1 |
| 170 | Cu | —CO₂—CH₂—CH₂—CH₂COOMt | 2 | 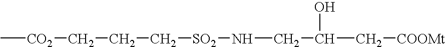 | 2 |

TABLE 10

| Compound No | M | R₁ | m | R₂ | n |
|---|---|---|---|---|---|
| 171 | Cu | —CO₂—CH₂—CH₂—O—CH₂—CH₂—O—CH₂—CH₂—SO₃Mt | 3 | 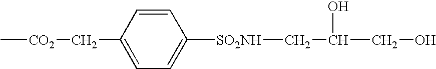 | 1 |
| 172 | Cu | —SO₂CH₂CH₂OCH₂CH₂O —CH₂CH₂SO₃Mt | 2 | 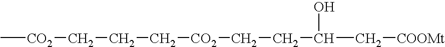 | 2 |
| 173 | Cu | 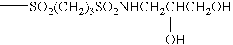 | 2 | 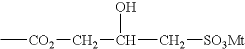 | 2 |
| 174 | Cu | 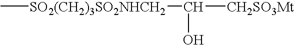 | 3 | 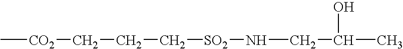 | |
| 175 | Cu | —SO₂(CH₂)₃SO₂NH(CH₂)₃N(CH₂CH₂OH)₂ | 2 | 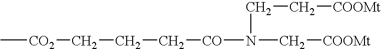 | 2 |
| 176 | Cu | 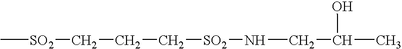 | 3 | 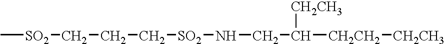 | 1 |
| 177 | Cu | —SO₂—CH₂—CH₂—O—CH₂—CH₂—O—CH₃ | 2 | 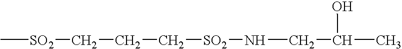 | 1 |
| 178 | Cu | —SO₂—CH₂—CH₂—O—CH₂—CH₂—O—CH₂—CH₂—OH | 3 | 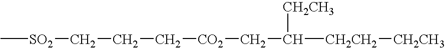 | 1 |
| 179 | Cu | 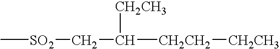 | 2 | 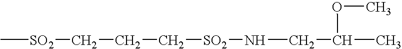 | 2 |
| 180 | Cu | 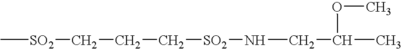 | 3 | —SO₂NH—CH₂—CH₂—SO₂NH—CH₂—CH₂—O—CCH₂—CH₂—OH | 1 |
| 181 | Cu | 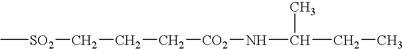 | 3 | —SO₂—CH₂—CH₂—CH₂—SO₂—NH—CH [symbol] CH₃)₂ | 1 |
| 182 | 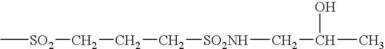 | 2.5 | 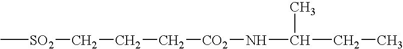 | 1.5 | |

TABLE 11

| Compound No. | M | R₁ | m |
|---|---|---|---|
| 183 | Cu | 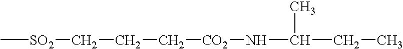 | 2 |
| 184 | Cu | 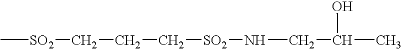 | 3 |
| 185 | Cu | 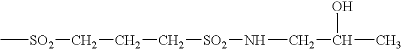 | 3 |
| 186 | Cu | 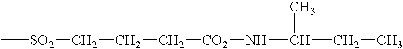 | 3 |
| 187 | Cu | —SO₂—CH₂—CH₂—CH₂—SO₂—NH—CH [symbol] CH₃)₂ | 3 |
| 188 | Cu | 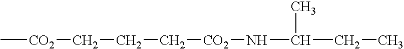 | 3 |
| 189 | Cu | —CO—NH—CH₂—CH₂—SO₂—NH—CH [symbol] CH₃)₂ | 3 |
| 190 | Cu | 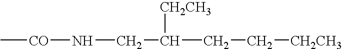 | 3 |

| Compound No. | R₂ | n |
|---|---|---|
| 183 | —SO₂—CH₂—CH₂—CH₂—SO₂—NH—(CH₂)₃—CH₂—O—CH₂CH₂—OH | 2 |
| 184 | —SO₂—CH₂—CH₂—O—CH₂—CH₂—O—CH₃ | 1 |
| 185 | —SO₂—CH₂—CH₂—O—CH₂—CH₂—O—CH₂—CH₂—O—CH₃ | 1 |
| 186 | —SO₂—CH₂—CH₂—O—CH₂—CH₂—O—CH₂—CH₂—OH | 1 |
| 187 | 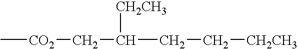 | 1 |
| 188 | —CO₂—CH₂—CH₂—O—CH₂—CH₂—O—CH₃ | 1 |
| 189 | 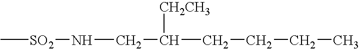 | 1 |
| 190 | —CO—NH—CH₂—CH₂—O—CH₂—CH₂—O—CH₃ | 1 |

TABLE 12

| Compound No. | M | R₁ | m | R₂ | n |
|---|---|---|---|---|---|
| 191 | Cu | —SO₃Mt | 1.4 | 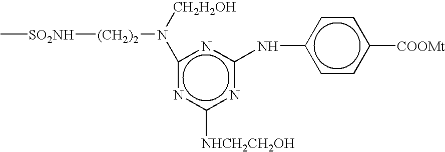 | 2.6 |
| 192 | Cu | —SO₃Mt | 1.4 | 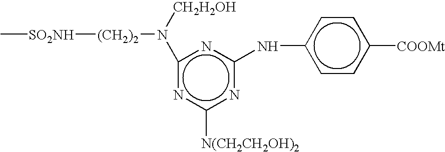 | 2.6 |
| 193 | Cu | —SO₃Mt | 2.0 | —SO₂NH₂ | 2.0 |
| 194 | Cu | —SO₂NH₂ | 2.0 | —SO₂NHCH₂CH₂SO₂Mt | 2.0 |
| 195 | Cu | —SO₂NH₂ | 2.0 | 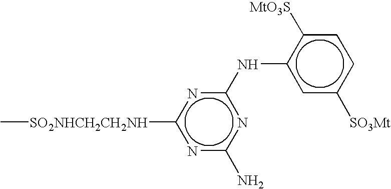 | 2.0 |

TABLE 13

| Compound No. | M | R₁ | m | R₂ | n |
|---|---|---|---|---|---|
| 196 | Cu | —SO₂NH₂ | 2.0 | 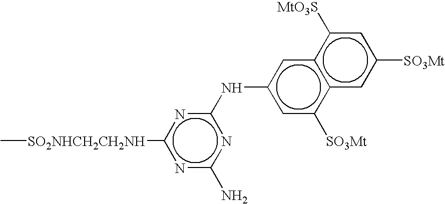 | 2.0 |
| 197 | Cu | —SO₂NH₂ | 2.0 | 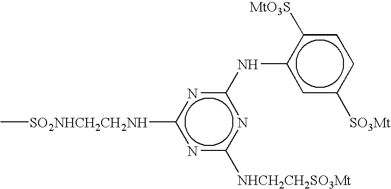 | 2.0 |

TABLE 14
*In Table 14, with specific examples of each combination of (A), (B),
(C) and (D), the orders are not special independently.

| Illustrative | | | | | |
|---|---|---|---|---|---|
| Compound | M | (A) | (B) | (C) | (D) |
| 201 | Cu | 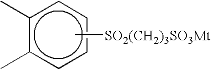 | 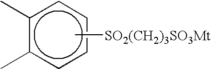 | 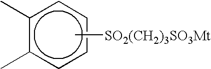 | 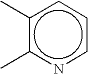 |
| 202 | Cu | 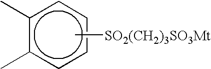 | 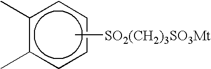 | 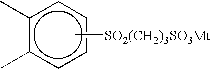 | 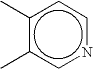 |
| 203 | Cu | 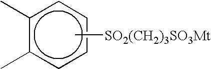 | 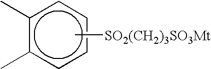 | 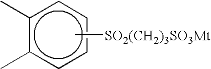 | 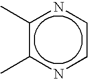 |
| 204 | Cu | 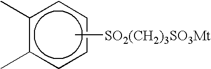 | 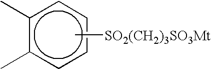 | 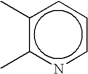 | 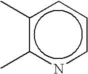 |
| 205 | Cu | 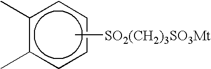 | 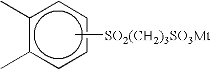 | 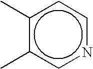 | 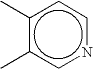 |

TABLE 15
*In Table 15, with specific examples of each combination of (A), (B),
(C) and (D), the orders are not special independently.

| Illustrative | | | |
|---|---|---|---|
| Compound | M | (A) | (B) |
| 206 | Cu | 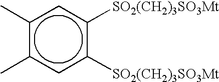 | 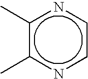 |
| 207 | Cu | 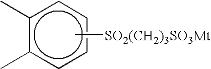 | 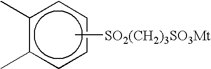 |
| 208 | Cu | 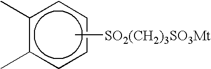 | 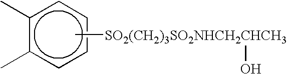 |
| 209 | Cu | 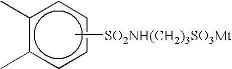 | 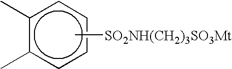 |
| 210 | Cu | 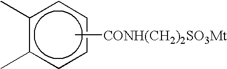 | 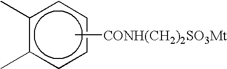 |

| Illustrative Compound | (C) | (D) |
|---|---|---|
| 206 | 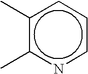 | 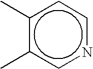 |
| 207 | 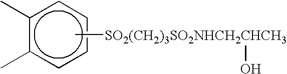 | 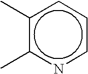 |
| 208 | 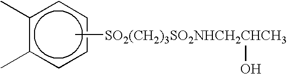 | 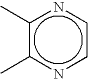 |
| 209 | 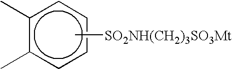 | 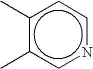 |
| 210 | 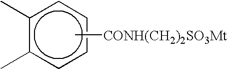 | 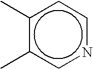 |

In Tables 1 to 15, Mt represents Li, Na or K. Tables 8 to 13 show the following phthalocyanines wherein M, R₁ and R₂ are changed. R₁ and R₂ are substituents at β-positions, with the introduction positions of respective substituents between the β-position substituents not being special.

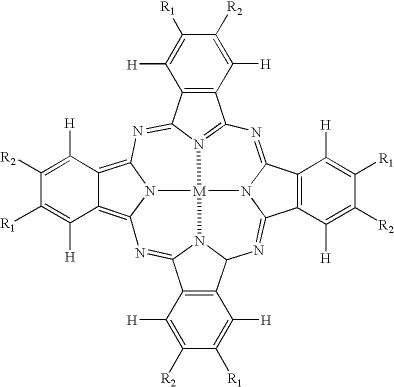

Tables 14 and 15 show phthalocyanines of the following structure having substituents introduced into A, B, C and D.

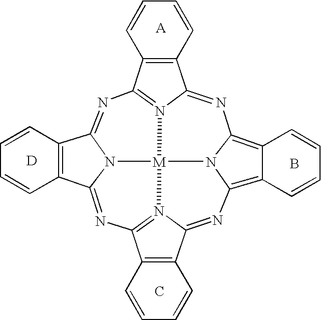

In addition to the above-described specific examples, those compounds may also be preferably used which are described in WO02/60994, WO03/811, WO03/62324, WO04/87815, WO/04/85541, JP-A-2003-213167, JP-A-2004-75986, JP-A-2004-323605, JP-A-2004-315758 and Japanese Patent Application No. 2003-421124. The phthalocyanine dyes of the invention can be synthesized according to the aforementioned patents as well as JP-A-2004-315729, Japanese Patent Application Nos. 2003-411390 and 2004-094413. The starting materials, dye intermediates and synthesis route are not limited by these documents.

The phthalocyanine of the invention can be used independently or may be used in combination with other dye, particularly other phthalocyanine dye.

In the invention, in order to reduce reactivity with an electrophilic agent of ozone, it is desirable to partially replace a carbon atom of the phthalocyanine skeleton by a hetero atom as with azaphthalocyanine or to introduce an electron attractive group into the phthalocyanine skeleton to render the oxidation potential nobler than 1.0 V (vs SCE). A nobler oxidation potential is more preferred. The oxidation potential is more preferably nobler than 1.1 V (vs SCE), most preferably nobler than 1.15 V (vs SCE).

The oxidation potential value (Eₒₓ) can be measured with ease by those skilled in the art. As to the measuring method, descriptions are given in, for example, P. Delahay; New Instrumental Methods in Electrochemistry, 1954, Interscience Publishers, and A. J. Bard, et al.; Electrochemical Methods, 1980, John Wiley & Sons, and Akira Fujishima et al.; Denki Kagaku Sokuteiho, 1984, Gihodo Shuppansha.

Specifically, oxidation potential is measured by dissolving a test sample in a concentration of 1×10−2 to 1×10−6 mol/liter in a solvent such as dimethylformamide or acetonitrile which contains a supporting electrolyte such as sodium perchlorate or tetrapropylammonium perchlorate, and employing various voltammetry methods (polarography using a dripping mercury electrode, cyclic voltammetry or method of using a rotating disk electrode) to determine as a value with respect to SCE (saturated calomel electrode). This value can fluctuate about several 10 mV by the influence of potential difference between liquids or liquid resistance of the sample solution. However, reproducibility of the potential can be assured by adding a standard sample (e.g., hydroquinone).

Additionally, in the invention, the oxidation potential of a dye was a value (vs SCE) determined by measuring in a solution of N,N-dimethylformamide containing 0.1 mol/liter of tetrapropylammonium perchlorate as a supporting electrolyte (dye concentration: 0.001 mol/liter) with SCE (saturated calomel electrode) as a reference electrode, a graphite electrode as a working electrode, and a platinum electrode as an opposite electrode.

The value of Eₒₓ represents mobility of electron from a sample to an electrode, and a larger value (oxidation potential being nobler) represents a low mobility of electron from a sample to an electrode, in other words, a less oxidizability. Regarding the structure of a compound, the oxidation potential becomes nobler by introducing an electron attractive group, whereas becomes less noble by introducing an electron donative group. In the invention, in order to reduce reactivity with an electrophilic agent of ozone, it is desirable to partially replace a carbon atom of the phthalocyanine skeleton by a hetero atom or to introduce an electron attractive group into the phthalocyanine skeleton to render the oxidation potential nobler.

Also, in the dye of the invention, bronzing phenomenon can be depressed by adding a colorless, water-soluble planar compound having more than 10 non-localized Π electrons per molecule. The blonzing phenomenon is a phenomenon that a recorded image with a high optical density suffers precipitation of dye crystals on the surface of a recording material with the progress of drying and, as a result, the recorded image reflects light to give a metallic gloss. This phenomenon tends to occur when water solubility of a dye is reduced or when a hydrogen bond-forming group is introduced into the dye structure in order to improve water resistance, light resistance and gas resistance.

Generation of the blonzing phenomenon leads to reflection and scattering of light, and hence there results a reduction in optical density of a recorded image and, in addition, hue of the recorded image seriously differs from what is desired or transparency is lost. Thus, to depress the blonzing phenomenon is one of the important performances required for an ink jet ink.

The colorless, water-soluble planar compound having more than 10 non-localized Π electrons per molecule will be described below. As the number of non-localized Π electrons increases to give a broader Π electro system, the compound often shows an absorption in the visible region. In the invention, “colorless” includes an extremely slightly colored state not influencing on an image. Also, a fluorescent compound may be used, though a compound not showing fluorescent property being preferred. The most preferred compounds are compounds which have λmax of an absorption peak at the longest wavelength is 350 nm or less, more preferably 320 nm or less and which have a molar extinction coefficient of 10,000 or less.

Such compounds have more than 10 non-localized Π electrons per molecule. There is no particular limit as to the upper limit of the number of Π electrons, but is preferably 80 or less, more preferably 50 or less, particularly preferably 30 or less. The more than 10 Π electrons may form one big non-localized system or may form two or more non-localized systems. In particular, compounds having two or more aromatic rings per molecule are preferred. The aromatic ring may be an aromatic hydrocarbon ring or an aromatic hetero ring containing a hetero atom, or may be condensed to form one aromatic ring system. Examples of the aromatic ring include benzene, naphthalene, anthracene, pyridine, pyrimidine, pyrazine and triazine.

The water-soluble, planar compound to be preferably used in the invention is preferably a compound which can be solved in an amount of at least 1 g per 100 g of water at 20° C., more preferably 5 g or more, most preferably 10 g or more.

With compounds having 2 or more aromatic rings per molecule, it is particularly preferred for the compounds to have at least 2 solubilizing groups bound to the aromatic ring rings within the molecule. Useful solubilizing groups include a sufo group, a carboxyl group, a hydroxyl group, a sphophono group, a carbonamido group, a sulfonamido group, a quaternary ammonium salt and other groups apparent to those skilled in the art which, however, are not limitative at all. Of these, a sulfo group and a carboxyl group are preferred, with a sulfo group being most preferred.

The maximum number of the solubilizing groups within the molecule is not limited only by the number of utilizable substitution positions but, for the practical purpose, it suffices for the solubilizing groups (same or different) to exist 10 in number within the molecule. A counter cation for the solubilizing group is not limited, and examples thereof include an alkali metal, ammonium and an organic cation (e.g., tetramethylammonium, guanidium or pyridinium). Of these, an alkali metal and ammonium are preferred, lithium, sodium, potassium and ammonium are particularly preferred, and lithium, sodium and ammonium are most preferred.

As specific compounds, there can be illustrated those compounds which are described in JP-A-63-55544, JP-A-3-146947, JP-A-3-149543, JP-A-2001-201831, JP-A-2002-139822, JP-A-2002-196460, JP-A-2002-244257, JP-A-2002-244259, JP-A-2002-296743, JP-A-2002-296744, JP-A-2003-255502, JP-A-2003-307823, JP-A-2004-4500 and JP-A-2004-170964.

Among them, compounds represented by the following formula VI are preferably used.
A-X-L-(Y—B)ₙ Formula VI:

In the above formula, A, L and B each independently represents an aromatic group (an aryl group or an aromatic hetero ring group). X and Y each independently represents a divalent linking group. n represents 0 or 1. The aromatic ring may be a single ring or a condensed ring. The divalent linking group is an alkylene group, an alkenylene group, —CO—, —SOₙ— (n: 0, 1 or 2), —NR— (wherein R represents a hydrogen atom, an alkyl group, an aryl group or a hetero ring group), —O— or a divalent group of combination of these linking groups. The compound represented by the formula VI has at least one ionic hydrophilic group selected from among a sulfo group, a carboxyl group, a phenolic hydroxyl group and a phosphono group. These ionic hydrophilic groups may be in a salt form. The counter cation thereof is not particularly limited, and examples thereof include an alkali metal, ammonium and an organic cation (e.g., tetramethylammonium, guanidium or pyridinium). Of these, an alkali metal and ammonium are preferred, lithium, sodium, potassium and ammonium are particularly preferred, and lithium, sodium and ammonium are most preferred.

Also, the compound represented by the general formula VI may have a substituent other than the ionic hydrophilic group. As specific examples of such substituent, there can be illustrated an alkyl group, an aryl group, an aralkyl group, a hetero ring group, an alkoxy group, an aryloxy group, a hydroxyl group, an amino group (including an aniline group and a hetero ring amino group), an acyl group, an acylamino group, a ureido group, a halogen atom, a sulfamoyl group, a carbamoyl group, a sulfonamide group, a sulfonyl group, a sulfenyl group and a sulfinyl group. These may further have a substituent. Of the compounds represented by the formula VI, compounds wherein n=1 are preferred. Also, compounds wherein at least one of A, L and B is an aromatic hetero ring are preferred. Further, compounds having from 2 to 4 ionic hydrophilic groups are preferred.

Typical compounds (anticoagulants) are shown below.

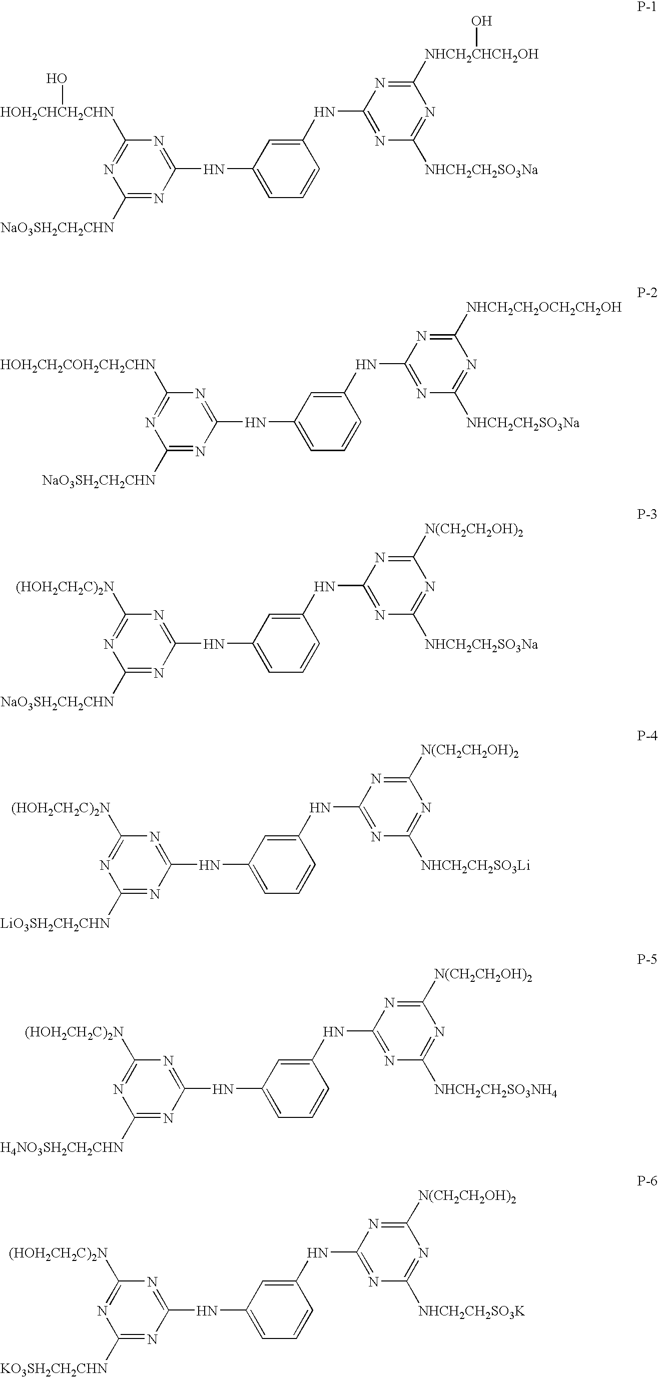

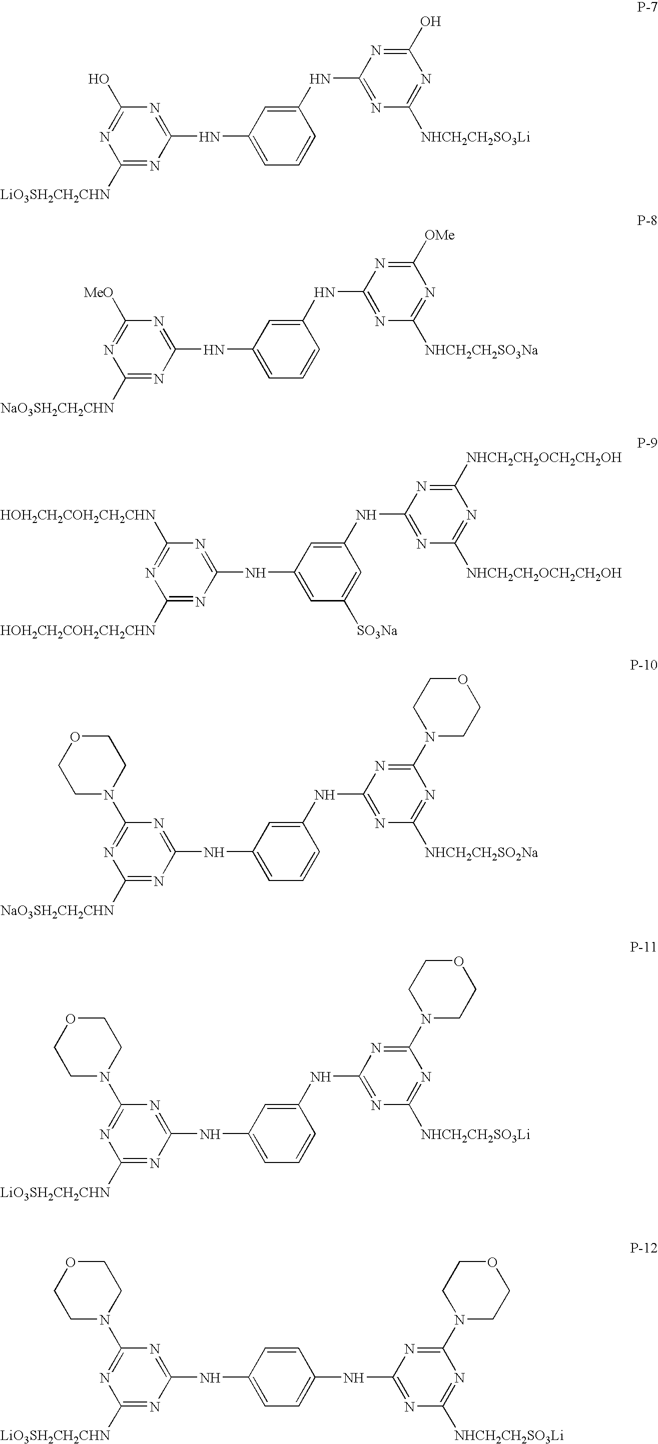

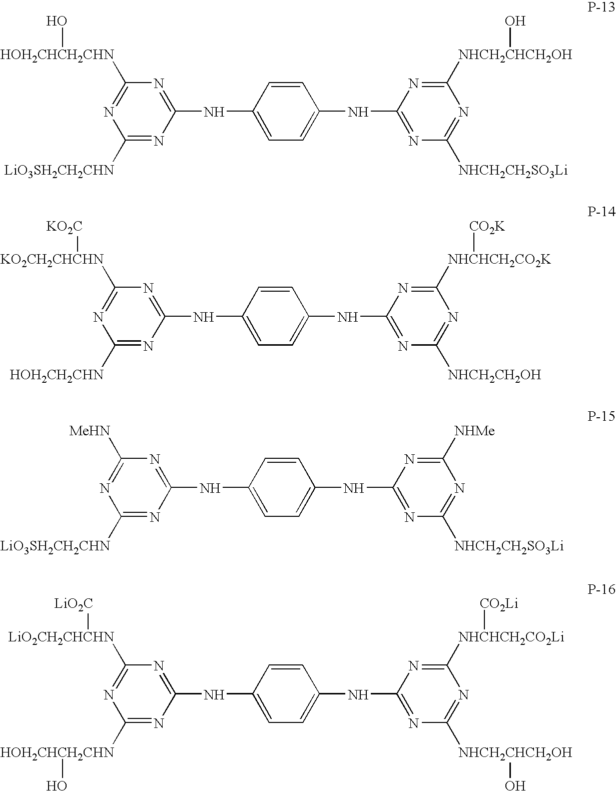

An ink jet ink can be prepared by dissolving and/or dispersing a coloring material in an oleophilic medium or an aqueous medium. In the case of using an aqueous medium, other additives are incorporated, as needed, within the range of not spoiling the advantages of the invention.l

As the other additives, there are illustrated, for example, known additives such as a drying-preventing agent (wetting agent), an anti-fading agent, an emulsion stabilizer, a penetration accelerator, a UV ray absorbent, an antiseptic, an antifungal agent, a pH-adjusting agent, a surface tension-adjusting agent, an antifoaming agent, a viscosity-adjusting agent, a dispersing agent, a dispersion stabilizer, a rust inhibitor and a chelating agent. With water-soluble inks, these various additives are directly added to an ink solution. In the case of using an oil-soluble dye in the form of dispersion, they are generally added to a prepared dispersion of a dye, but may be added to an oil phase or an aqueous phase upon preparation of the dye dispersion.

The drying-preventing agent is preferably used for the purpose of preventing clogging due to drying of the ink jet ink in the ink-ejecting orifice of a nozzle to be used in the ink jet recording system. As such drying-preventing agent, a water-soluble organic solvent having a vapor pressure lower than that of water is preferred. Specific examples thereof include polyhydric alcohols represented by ethylene glycol, propylene glycol, diethylene glycol, polyethylene glycol, thiodiglycol, dithiodiglycol, 2-methyl-1,3-propanediol, 1,2,6-hexanetriol, acetylene glycol derivative, glycerin and trimethylolpropane; lower alkyl ethers of polyhydric alcohols such as ethylene glycol monomethyl (or ethyl)ether, diethylene glycol monomethyl (or ethyl)ether and triethylene glycol monoethyl (or butyl)ether; hetero rings such as 2-pyrrolidone, N-methyl-2-pyrrolidone, 1,3-dimethyl-2-imidazolidinone and N-ethylmorpholine; sulfur-containing compounds such as sulfolane, dimethylsulfoxide and 3-sulfolene; polyfunctional compounds such as diacetone alcohol and diethanolamine; and urea derivatives. Of these, polyhydric alcohols such as glycerin and diethylene glycol are more preferred. Also, these drying-preventing agents may be used independently or in combination of two or more thereof. These drying-preventing agents are incorporated in an ink in a content of preferably from 10 to 50% by mass.

The penetration accelerator is preferably used for the purpose of penetrating an ink for ink jet recording into paper. As the penetration accelerator, alcohols such as ethanol, isopropanol, butanol, di(tri)ethylene glycol monobutyl ether and 1,2-hexanediol, sodium laurylsulfate, sodium oleate, and nonionic surfactants. These exhibit sufficient effects when incorporated in an ink in a content of from 5 to 30% by mass and are preferably used in an amount not causing blurring or print-through of printed letters.

A UV ray absorbent is used for the purpose of improving preservability of an image. As the UV ray absorbent, benzotriazole series compounds described in JP-A-58-185677, JP-A-61-190537, JP-A-2-782, JP-A-5-197075 and JP-A-9-34057; benzophenone series compounds described in JP-A-46-2784, JP-A-5-194483 and U.S. Pat. No. 3,214,463; cinnamic acid series compounds described in JP-B-48-30492, JP-A-56-21141 and JP-A-10-88106; triazine series compounds described in JP-A-4-298503, JP-A-8-53427, JP-A-8-239368, JP-A-10-182621 and JP-T-8-501291 (the term “JP-T” as used herein means a published Japanese translation of a PCT patent application); compounds described in Research Disclosure, No. 24239; and so-called fluorescent brightening agents which absorb UV rays to emit fluorescence, represented by stilbene series and benzoxazole series compounds.

The anti-fading agent is used for the purpose of improving preservability of an image. As such anti-fading agent, various organic and metal complex series anti-fading agents can be used. As the organic anti-fading agent, there are illustrated hydroquinones, alkoxyphenols, dialkoxyphenols, phenols, anilines, amines, indanes, chromans, alkoxyanilines and hetero rings and, as the metal complex, there are illustrated nickel complexes and zinc complexes. More specifically, compounds described in patents cited in Research Disclosure, No. 17643, VII, items I to J, ibid., No. 15162, ibid., No. 18716, p. 650, left column, ibid., No. 36544, p. 527, ibid., No. 307105, p. 872, and ibid., No. 15162 and compounds included by the formula of typical compounds and compound examples, described in JP-A-62-215272, pp. 127-137 can be used.

As the antifungal agent, there are illustrated sodium dehydroacetate, sodium benzoate, sodium pyridinethione-1-oxide, ethyl p-hydroxybenzoate, 1,2-benzisothiazolin-3-one and salts thereof. These are used in an ink in a content of preferably from 0.02 to 1.00% by mass.

As a pH-adjusting agent, there can be used the aforesaid neutralizing agents (organic bases and inorganic alkalis). The pH-adjusting agent is added to an ink for ink jet recording for the purpose of improving storage stability of the ink in an amount so that the pH of the ink becomes from 6 to 10 in pH, more preferably from 7 to 10 in pH.

As the surface tension-adjusting agent, there are illustrated nonionic, cationic, anionic and betaine surfactants. The addition amount of the surface tension-adjusting agent is preferably in an amount enough to adjust the surface tension of the ink of the invention to 20 to 60 mN/m, more preferably 20 to 45 nN/m, still more preferably 25 to 40 mN/m, for the purpose of well impacting with ink droplets by means of an ink jet recording apparatus. As examples of hydrocarbon series surfactants, anionic surfactants such as fatty acid salts, alkyl sulfate salts, alkylbenzenesulfonates, alkylnaphthalenesulfonates, dialkylsulfosuccinates, alkyl phosphate salts, naphthalenesulfonic acid-formalin condensate and polyoxyethylene alkyl sulfate salts and nonionic surfactants such as polyoxyethylene alkyl ethers, polyoxyethylene alkylaryl ethers, polyoxyethylene fatty acid esters, sorbitan fatty acid esters, polyoxyethylene sorbitan fatty acid esters, polyoxyethylenealkylamines, glycerin fatty acid esters, oxyethylene-oxypropylene block copolymers are preferred. Also, an acetylene series polyoxyethylene oxide surfactant of SURFYNOLS (Air Products & Chemicals Co.) is preferably used. Amine oxide type amphoteric surfactants such as N,N-dimethyl-N-alkylamine oxide are preferred as well. Further, those described as surfactants in JP-A-59-157636, pp. 37-38, Research Disclosure No. 308119 (1989) can also be used. Further, fluorine-containing (fluoroalkyl-containing) or silicone series surfactants as described in JP-A-2003-322926, JP-A-2004-325707 and JP-A-2004-309806 can be used. These surface tension-adjusting agents can also be used as the antifoaming agents, and fluorine-containing or silicone series compounds or chelating agents represented by EDTA can be used as well.

The viscosity of the ink of the invention for ink jet recording is preferably 30 mPa·s or less, more preferably 20 mPa·s. The aqueous medium contains water as a major component and, as needed, a mixture prepared by adding a water-miscible organic solvent can be used. Examples of the water-miscible organic solvent include alcohols (e.g., methanol, ethanol, propanol, isopropanol, butanol, isobutanol, sec-butanol, t-butanol, pentanol, hexanol, cyclohexanol and benzyl alcohol), polyhydric alcohols (e.g., ethylene glycol, diethylene glycol, triethylene glycol, polyethylene glycol, propylene glycol, dipropylene glycol, polypropylene glycol, butylenes glycol, hexanediol, pentanediol, glycerin, hexanetriol and thiodiglycol), glycol derivatives (e.g., ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether and ethylene glycol monophenyl ether), amines (e.g., ethanolamine, diethanolamine, triethanolamine, N-methyldiethanolamine, N-ethyldiethanolamine, morpholine, N-ethylmorpholine, ethylenediamine, diethylenetriamine, triethylenetetramine and polyethyleneimine, tetramethylpropylenediamine) and other polar solvents (e.g., formamide, N,N-dimethylformamide, N,N-dimethylacetamide, dimethylsulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile and acetone). Additionally, the water-miscible organic solvents may be used in combination of two or more thereof.

The ink of the invention for ink jet recording can be used for forming not only a cyan-color (monocolor) image but a full-color image as well. In order to form a full-color image, a magenta-color ink, a cyan-color ink and a yellow-color ink can be used. In addition, in order to improve color tone, a black-color ink may further be used. Also, a red, green, blue or white ink other than the yellow-, magenta- and cyan-color inks and special-color inks in the so-called printing field can also be used.

As yellow dyes, any yellow dye can be used. There are illustrated, for example, aryl or heterylazo dyes having as a coupling component (hereinafter referred to as a coupler component) a phenol, a naphthol, an aniline, a hetero ring (e.g., pyrazoline or pyridine) or an open-chain type active methylene compound; azomethine dyes having as a coupler component an open-chain type active methylene compound or the like; methine dyes such as benzylidene dyes and monomethineoxonol dyes; and quinone series dyes such as naphthoquinone dyes and anthraquinone dyes. As other dye species, there can be illustrated quinophthalone dyes, nitro-nitroso dyes, acridine dyes and acridinone dyes.

For example, as dyes described in Color Index, C.I. Acid Yellow 17, C.I. Acid Yellow 23, C.I. Acid Yellow 42, C.I. Acid Yellow 44, C.I. Acid Yellow 79, C.I. Acid Yellow 142, C.I. Direct Yellow 33, C.I. Direct Yellow 44, C.I. Direct Yellow 50, C.I. Direct Yellow 86, C.I. Direct Yellow 144 and C.I. Reactive Yellow 17 can be applied.

As magenta dyes, any magenta dye can be used. There are illustrated, for example, aryl or heterylazo dyes having as a coupler component a phenol, a naphthol or an aniline; azomethine dyes having as a coupler component a pyrazolone or a pyrazolotriazole; methine dyes such as arylidene dyes, styryl dyes, merocyanine dyes, cyanine dyes and oxonol dyes; carbonium dyes such as diphenylmethane dyes, triphenylmethane dyes and xanthene dyes; quinone series dyes such as naphthoquinone dyes, anthraquinone dyes and anthrapyridone dyes; and condensed polycyclic dyes such as dioxazine dyes.

For example, C.I. Acid Red 35, C.I. Acid Red 42, C.I. Acid Red 52, C.I. Acid Red 82, C.I. Acid Red 87, C.I. Acid Red 92, C.I. Acid Red 134, C.I. Acid Red 249, C.I. Acid Red 254, C.I. Acid Red 289, C.I. Direct Red 4, C.I. Direct Red 95, C.I. Direct Red 242, C.I. Direct Red 9, C.I. Direct Red 17, C.I. Direct Red 28, C.I. Direct Red 81, C.I. Direct Red 83, C.I. Direct Red 89, C.I. Direct Red 225, C.I. Direct Red 227 and C.I. Reactive Red 6, described in Color Index, can be applied.

As cyanine dyes to be used in combination with the phthalocyanine dyes of the invention, any cyan dye can be used. There are illustrated, for example, aryl or heterylazo dyes having as a coupler component a phenol, a naphthol or aniline; azomethine dyes having as a coupler component a phenol, a naphthol or a hetero ring (e.g., pyrrolotriazole); polymethine dyes such as cyanine dyes, oxonol dyes and merocyanine dyes; carbonium dyes such as diphenylmethane dyes, triphenylmethane dyes and xanthene dyes; anthraquinone dyes; and indigo•thioindigo dyes. For example, C.I. Acid Blue 1, C.I. Acid Blue 9, C.I. Acid Blue 15, C.I. Acid Blue 59, C.I. Acid Blue 93, C.I. Acid Blue 249, C.I. Direct Blue 15, C.I. Direct Blue 76, C.I. Direct Blue 86, C.I. Direct Blue 200, C.I. Direct Blue 201, C.I. Direct Blue 202 and C.I. Reactive Blue 2, described in Color Index, can be applied.

The aforesaid dyes may be in a form which gives the color of yellow, magenta or cyan only when part of the chromophore is dissociated. A counter cation in such case may be an inorganic cation such as an alkali metal or ammonium or an organic cation such as pyridinium or a quaternary ammonium salt, or may be a polymer cation having them as a partial structure thereof.

As an applicable black color material, there can be illustrated disazo, trisazo and tetraazo dyes and a dispersion of carbon black. As dyes described in Color Index, C.I. Acid Black 2, C.I. Food Black 2, C.I. Direct Black 19, C.I. Direct Black 22, C.I. Direct Black 32, C.I. Direct Black 51 and C.I. Direct Black 154 can be applied.

Also, dyes of other colors than yellow, magenta and cyan (e.g., red, blue and green) can be used.

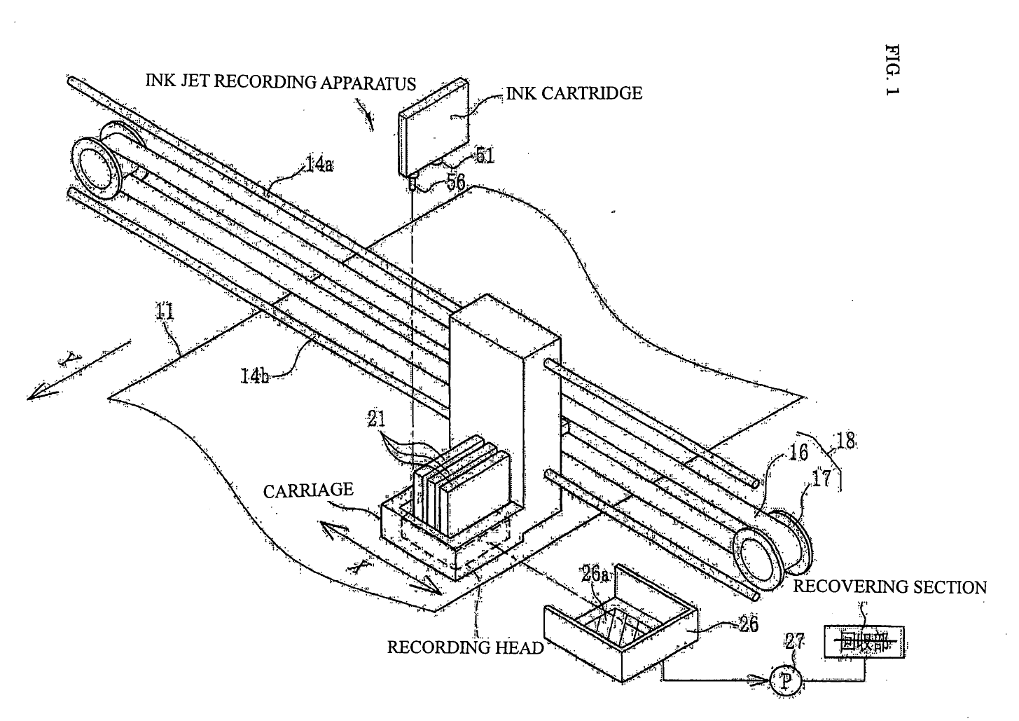

An ink jet recording apparatus to be preferably used for the invention will be described below. An ink jet recording apparatus 10 shown in FIG. 1 has a recording head 12 which ejects an ink toward paper 11 to deposit the ink thereonto to thereby record an image. The recording head 12 has a plurality of nozzles each having formed therein an ink-ejecting orifice, and is disposed so that the ink-ejecting side where plural orifices of the nozzles are arranged faces the recording side of the paper 11. The recording head 12 is fit to a carriage 13 movable in the width direction of the paper 11 (main scanning direction X), and the ink-ejecting side is laid bare in the opening formed at the bottom of the carriage 13. The recording head 12 reciprocates along the width direction of the paper 11 to the movement of the carriage 13 to line-record and image. Every time this recording head 12 makes one reciprocation, the paper 11 is moved in the sub-scanning direction Y by a convey roller not shown by the width recorded through one reciprocation of the recording head 12. Such operation is repeated to perform recording of an image for one picture.

The carriage 13 is slidably fit to guide rods 14a and 14b and is driven by means of a belt mechanism 18 comprising a belt 16 and a pair of pulleys 17. On the carriage 13 and above the recording head 12 are removably mounted 4 ink cartridges 21 respectively retaining inks of 4 colors of, for example, Y, M, C and K. Plural slots for inserting respective ink cartridges 21 are formed within the carriage 13.

The ink cartridges 21 are mounted with the lower side thereof facing the bottom side of the slots. When the ink cartridges 21 are mounted on the carriage 13, ink cartridges 21 and the recording head 12 connect to each other through an ink-feeding passage. In the recording head 12, vibrating plates to be driven by a piezo element are provided corresponding to respective nozzles. An ink within each ink cartridge 21 is sucked to the nozzle by change in pressure due to vibration of the vibrating plate, and ejected through the ink-ejecting orifice.

Except for recording operation, the carriage 13 moves out of the convey route of the recording paper 11 and wait in readiness. This waiting position is a home position of the carriage 13, and exchange of the ink cartridges 21 is conducted at this home position. At the home position, a head cap 26 is disposed which covers the ink-ejecting side of the recording head 12 from under the head to receive an ink leaked from the ink-ejecting side. An ink-sucking side 26a for sucking an ink clogging the tip of the nozzle is disposed in the head cap 26 at a position facing the ink-ejecting side. The head cap 26 is connected to a suction pump 27 for restoring good ejection of an ink-clogged nozzle by sucking an ink clogging the nozzle through the sucking side 21a. An ink recovered by this suction pump 27 is recovered in a recovering section 28.

Additionally, in FIG. 1, an example of a shuttle type head, but the invention can be applied to a line head having the width of paper.

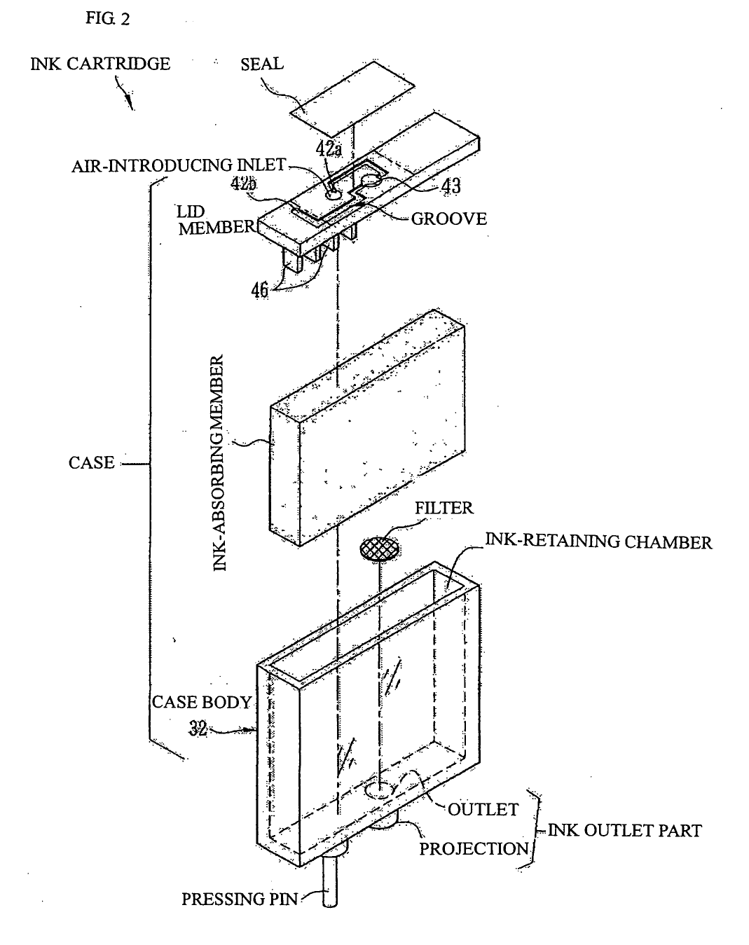

An ink cartridge to be preferably used in the invention will be described below. As is shown in FIG. 2, an ink cartridge 21 is equipped with a case 34 retaining an ink. This case 34 comprises a case body 32 forming an ink-retaining chamber 35 and a lid member 33 for closing the upper opening of the case body 32. The lid member is, for example, welded to the case body 32 after filling the case body 32 with an ink for preventing leakage of the ink from the upper opening. The case body 32 is formed by, for example, a transparent plastic so that a remaining amount of the ink within the ink cartridge 21 can visually be checked.

An ink-absorbing member 36 which absorbs an ink to hold it is placed in the ink-retaining chamber 35. This ink-absorbing member 36 is a spongy member having fine voids which generate capillary force. Specifically, various porous materials such as a foam material and a fibrous material are used. In the invention, polyolefins (resins) are preferably used. The ink-absorbing member 36 has the same width and depth as those of the ink-retaining chamber 35, and the outer surface is held in a state of being in contact with the inner wall of the ink-retaining chamber 25 except for the upper side.

The case 34 is disposed above the recording head 12, and hence a load of the ink within the case 34 applies a positive pressure to the recording head 12. The ink-absorbing member 36 absorbs the ink by its capillary force and functions as a negative pressure-generating member which keeps the pressure within the nozzle of the recording head 12 negative (versus atmosphere). This serves to prevent undesirable leakage of the ink within the recording head 12.

An air-introducing inlet 41 is formed in the lid member 33. This air-introducing inlet 41 functions to take into the ink-retaining chamber 35 an air in an amount corresponding to the amount of consumed ink. A winding groove 42 is formed in the upper side of the lid member 33. One end 42a of this groove 42 is connected to the air-introducing inlet 41, and a liquid reservoir 43 is provided on the passage running toward the other end 42b. Of the groove 42, a portion other than the other end 42b (a portion between two two-dot-and-dash lines) is sealed with a seal 45 at its upper side, with leaving only the other end 42b bare. This groove 42 functions so that, when the ink within the ink-retaining chamber 25 is leaked through the air-introducing inlet 41, the leaked ink is introduced to the liquid reservoir 43 to thereby prevent ink leakage out of the ink cartridge 21. An air enters through the other end 42b and is introduced to the air-introducing inlet 41.

A plurality of ribs 46 projecting downward are provided at the lower side of the lid member 33. When the lid member 33 is fit to the case body 32, each rib 46 enters into the ink-retaining chamber 35 and comes into contact with the ink-absorbing member 36 held therein, thus pressing the ink-absorbing member 36 so that the lower side is pressed against the bottom of the ink-retaining chamber 35. Thus, position of the ink-absorbing member 36 is fixed, whereby a space is secured between the ink-absorbing member 36 and the lid member 33. Since position of the ink-absorbing member 36 is fixed by the ribs 46, the ink-absorbing member 36 never closes up the air-introducing inlet 41 due to positional deviation of the ink-absorbing member 36.

An ink outlet part 51 for taking an ink out of the ink-retaining chamber 35 and feeding it to the recording head 12 is provided under the case 34. The ink outlet part 51 comprises, for example, an almost circular outlet 51a formed at the bottom of the case 34 and a cylindrical projection 51b projecting from this outlet 51a downward. An almost planar filter 54 is disposed in the bottom side of the ink-retaining chamber 35 at the position of this outlet 51a. The lower side 54a (exposed side) of the filter 54 is laid bare through the outlet 51a.

The filter 54 is a mesh filter wherein many small pores are arranged in a network pattern, and functions to filter an ink taken out through the outlet 51a. This filter 54 serves to prevent invasion of an ink having been coagulated within the ink-retaining chamber 35 or foreign matters into the recording head 12. The diameter of the small pores of the filter 54 is, for example, preferably from about 5 μm to about 20 μm. Use of such fine filter 54 assures prevention of invasion of dust into the ink-retaining chamber 35 from outside of the case 34 through the outlet 51a.

However, the fine filter 54 shows such a large passage resistance when an ink passes therethrough that there arises a large loss of suction pressure. Therefore, in the ink cartridge 21 and the ink jet recording apparatus 10 of the invention, a technique is employed which reduces the pressure loss due to the filter 54 when the ink cartridge 21 is mounted on the ink jet recording apparatus 10.

A pressing pin 56 is provided at the lower side of the case 34, with one end being fixed to the case 34 and the other end extending downward to form a free end. As will be described hereinafter, this pressing pin 56 is a pressing member which constitutes an ink-pressing mechanism which presses an ink within the ink-feeding line to generate a reverse flow toward the case 34 in the reverse direction to the ink-feeding direction toward the recording head 12 and feed the ink toward the filter 54. To feed the ink from the ink-feeding line toward the filter 54 as described above connects the ink within the ink-feeding line and the ink within the case 34 and serves to reduce the pressure loss.

### EXAMPLES

Next, the invention will be described in more detail by reference to Examples.

### Example 1

(Ink-Contacting Member)

Following tanks (the same shape as BCI-3e (model No.; manufactured by Canon) were prepared by using various members as ink-contacting members.

Tank A: A polypropylene tank was molded.

Tank B: A hydrotalcite-like compound represented by Mg₁₋ₓAlₓ(OH)₂(CO₃)_{x/2}.mH₂O (0<x≦0.5) (DHT-4A; manufactured by Kyowa Kagaku Kogyo K.K.) was mixed as a neutralizing agent in a content of 0.05% with polypropylene, and kneaded to produce pellets, followed by molding a tank using them.

Tank C: Calcium stearate was mixed in a content of 0.01% with polypropylene, and kneaded to produce pellets, followed by molding a tank using them.

Tank D: Tris(4-t-butyl-2,6-dimethyl-3-hydroxybenzyl)isocyanurate was mixed in a content of 0.2% with polypropylene, and kneaded to produce pellets, followed by molding a tank using them.

Tank E: Bis(m,p-dimethylbenzylidene)sorbitol was mixed in a content of 0.2% with polypropylene, and kneaded to produce pellets, followed by molding a tank using them.

Tank F: A polyethylene tank was molded.

Tank G: A hydrotalcite-like compound represented by Mg₁₋ₓAlₓ(OH)₂(CO₃)_{x/2}.mH₂O (0<x≦0.5) (DHT-4A; manufactured by Kyowa Kagaku Kogyo K.K.) was mixed as a neutralizing agent in a content of 0.05% with polyethylene, and kneaded to produce pellets, followed by molding a tank using them.

Tank H: Calcium stearate was mixed in a content of 0.01% with polyethylene, and kneaded to produce pellets, followed by molding a tank using them.

Tank I: Tris(4-t-butyl-2,6-dimethyl-3-hydroxybenzyl)isocyanurate was mixed in a content of 0.2% with polyethylene, and kneaded to produce pellets, followed by molding a tank using them.

Tank J: Bis(m,p-dimethylbenzylidene)sorbitol was mixed in a content of 0.2% with polyethylene, and kneaded to produce pellets, followed by molding a tank using them.

Also, tanks K to M were prepared by using, as comparative additives to polypropylene, lithium aluminum composite hydroxide compound [LiAl₂(OH)₆]₂CO₃.6H₂O described in JP-A-10-139941, an organic phosphorus-containing antioxidant of trisnonylphenylphosphite described in JP-A-10-87907 and a thioether series antioxidant of dilauryl thiodipropionate, respectively.

Tank K: Lithium aluminum composite hydroxide compound [LiAl₂(OH)₆]₂CO₃.1.6H₂O was mixed in a content of 0.05% with polyethylene, and kneaded to produce pellets, followed by molding a tank using them.

Tank L: An organic phosphorus-containing antioxidant of trisnonylphenylphosphite was mixed in a content of 0.2% with polyethylene, and kneaded to produce pellets, followed by molding a tank using them.

Tank M: A thioether series antioxidant of dilauryl thiodipropionate was mixed in a content of 0.2% with polyethylene, and kneaded to produce pellets, followed by molding a tank using them.

The following components were mixed in the following compounding ratios and were dissolved, followed by subjecting them to pressure filtration using a membrane filter of 1 μm in pore size to thereby prepare respective ink compositions. Additionally, “%” is by mass unless otherwise specified.

(Ink Formulation)

Dye shown in Table 16: 3%

Triethylene glycol: 15%

2-Pyrrolidone: 5%

Olfin E1010 (manufactured by Nissin

Chemical Co., Ltd.): 1%

Diethylene glycol monobutyl ether: 10%

Triethanolamine: 1%

Potassium hydroxide: 0.3%

Proxel XL-2 (manufactured by AVECIA): 0.3%

Ion-exchanged water: balance

As a comparative compound of cyan dye, the following comparative compound 1 was used. Additionally, the oxidation potential of the compound 100 of the invention (Mt═Li) is 1.18, and the oxidation potential of the comparative compound 1 is 0.7 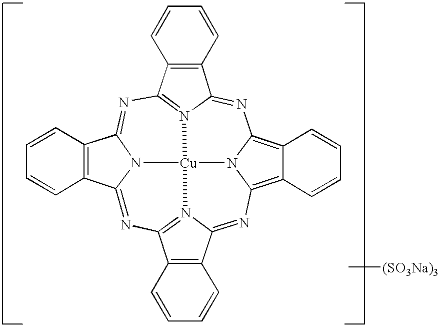
(Evaluation of Ejection Accuracy)

Each of the cyan dyes shown in Table 16 was poured into each of the ink tanks (of the same shape as BCI-3e (model No.; manufactured by Canon) comprising the ink-contacting members shown in Table 16, followed by leaving for 2 weeks in a 70° C. environment. As an ink jet recording apparatus, a commercially available ink jet recording printer PIXUS6500i (trade name; manufactured by Canon) was used, and a 50% duty solid pattern was printed continuously on A4-size photographic paper “Kotaku” (manufactured by Seiko Epson) using each of the above-conditioned inks till the ink consumption amount reached 10 mL. Subsequently, 1000 droplets were ejected through the same nozzle in a line pattern. Difference between the target impact position and the center of gravity of impact ink was measured, and the standard deviation was determined from data on 1000 droplets. Also, the area of each impact ink droplet was measured, and the standard deviation was determined from data on 1000 droplets. The results are shown in Table 16 with the value of the standard deviation with Experiment 101 being standardized as 100. A smaller number means a smaller fluctuation, thus being preferred.

TABLE 16

| | | | | Fluctuation in | |
|---|---|---|---|---|---|
| | Cyan Color | | Fluctuation in Droplet | Area of Impact | |
| | Material | Ink-contacting Member | Impact Position | Droplet | Note |
| Experiment 101 | Comparative | Tank F: polyethylene | 100 | 100 | Comparative |
| | Compound 1 | | | | Ex. |
| Experiment 102 | Comparative | Tank G: polyethylene | 101 | 98 | Comparative |
| | Compound 1 | (hydrotalcite added) | | | Ex. |
| Experiment 103 | Comparative | Tank H: polyethylene | 98 | 99 | Comparative |
| | Compound 1 | (calcium stearate added) | | | Ex. |
| Experiment 104 | Comparative | Tank I: polyethylene | 99 | 102 | Comparative |
| | Compound 1 | (phenolic antioxidant | | | Ex. |
| | | added) | | | |
| Experiment 105 | Comparative | Tank J: polyethylene | 102 | 103 | Comparative |
| | Compound 1 | (sorbitol added) | | | Ex. |
| Experiment 106 | Comparative | Tank A: polypropylene | 101 | 98 | Comparative |
| | Compound 1 | | | | Ex. |
| Experiment 107 | Comparative | Tank B: polypropylene | 97 | 103 | Comparative |
| | Compound 1 | (hydrotalcite added) | | | Ex. |
| Experiment 108 | Comparative | Tank C: polypropylene | 101 | 97 | Comparative |
| | Compound 1 | (calcium stearate added) | | | Ex. |
| Experiment 109 | Comparative | Tank D: polypropylene | 103 | 96 | Comparative |
| | Compound 1 | (phenolic antioxidant | | | Ex. |
| | | added) | | | |
| Experiment 110 | Comparative | Tank E: polypropylene | 98 | 102 | Comparative |
| | Compound 1 | (sorbitol added) | | | Ex. |
| Experiment 111 | Compound 101 | Tank F: polyethylene | 98 | 103 | Comparative |
| | of the invention | | | | Ex. |
| Experiment 112 | Compound 101 | Tank G: polyethylene | 91 | 88 | Present |
| | of the invention | (hydrotalcite added) | | | Invention |
| Experiment 113 | Compound 101 | Tank H: polyethylene | 89 | 91 | Present |
| | of the invention | (calcium stearate added) | | | Invention |
| Experiment 114 | Compound 101 | Tank I: polyethylene | 88 | 92 | Present |
| | of the invention | (phenolic antioxidant | | | Invention |
| | | added) | | | |
| Experiment 115 | Compound 101 | Tank J: polyethylene | 90 | 88 | Present |
| | of the invention | (sorbitol added) | | | Invention |
| Experiment 116 | Compound 101 | Tank A: polypropylene | 96 | 97 | Comparative |
| | of the invention | | | | Ex. |
| Experiment 117 | Compound 101 | Tank B: polypropylene | 82 | 83 | Present |
| | of the invention | (hydrotalcite added) | | | Invention |
| Experiment 118 | Compound 101 | Tank C: polypropylene | 85 | 86 | Present |
| | of the invention | (calcium stearate added) | | | Invention |
| Experiment 119 | Compound 101 | Tank D: polypropylene | 81 | 84 | Present |
| | of the invention | (phenolic antioxidant | | | Invention |
| | | added) | | | |
| Experiment 120 | Compound 101 | Tank E: polypropylene | 85 | 81 | Present |
| | of the invention | (sorbitol added) | | | Invention |
| Experiment 121 | Compound 101 | Tank K: polypropylene | 101 | 98 | Comparative |
| | of the invention | (lithium aluminum | | | Ex. |
| | | composite hydroxide | | | |
| | | added) | | | |
| Experiment 122 | Compound 101 | Tank L: polypropylene | 102 | 100 | Comparative |
| | of the invention | (organic phosphorus- | | | Ex. |
| | | containing antioxidant | | | |
| | | added) | | | |
| Experiment 123 | Compound 101 | Tank M: polypropylene | 98 | 101 | Comparative |
| | of the invention | (thioether series | | | Ex. |
| | | antioxidant added) | | | |

As can be seen from Experiments 101 to 110, in the evaluation on ink ejection accuracy using Comparative compound 1 as a cyan color material in an ink and after storing at an elevated temperature, influence of polyethylene or polypropylene used as an ink-contacting member on ejection accuracy can be said to be small. As can be seen from Experiments 111 and 116, use of the compound of the invention as a cyan color material for an ink exerts only a small influence on the ejection accuracy when the ink-contacting member is polyethylene or polypropylene. However, as can be Seen from Experiments 112 to 115 and 117 to 120, the ejection accuracy was improved with significance by using the compound of the invention as a cyan color material and using the polyethylene or the polypropylene of the invention as the ink-contacting member. Also, as can be seen from Experiments 121 to 123, combinations of polypropylenes containing additives outside the invention and the cyan color material of the invention are found to be ineffective.

### Example 2

Inks having the formulation of containing a water-soluble planar compound P-1 in a content of 2% were prepared. Whether the compound was added or not is shown in Table 17.

TABLE 17

| | | | | Fluctuation | Fluctuation | |
|---|---|---|---|---|---|---|
| | | | | in | in | |
| | | | Water-soluble, | Droplet | Area of | |
| Experiment | | Ink-contacting | Planar | Impact | Impact | |
| No. | Cyan Dye | Member | Compound | Position | Droplet | Note |
| 201 | Comparative | Tank F: | none | 100 | 100 | Comparative Ex. |
| | Compound 1 | polyethylene | | | | |
| 202 | Comparative | Tank B: | none | 97 | 103 | Comparative Ex. |
| | Compound 1 | polypropylene | | | | |
| | | (hydrotalcite | | | | |
| | | added) | | | | |
| 203 | Compound | Tank F: | none | 98 | 103 | Comparative Ex. |
| | 101 of the | polyethylene | | | | |
| | invention | | | | | |
| 204 | Compound | Tank B: | none | 82 | 83 | Present Invention |
| | 101 of the | polypropylene | | | | |
| | invention | (hydrotalcite | | | | |
| | | added) | | | | |
| 205 | Comparative | Tank F: | compound | 101 | 102 | Comparative Ex. |
| | Compound 1 | polyethylene | P-1(2% added) | | | |
| 206 | Comparative | Tank B: | compound | 99 | 100 | Comparative Ex. |
| | Compound 1 | polypropylene | P-1(2% added) | | | |
| | | (hydrotalcite | | | | |
| | | added) | | | | |
| 207 | Compound | Tank F: | compound | 100 | 101 | Comparative Ex. |
| | 101 of the | polyethylene | P-1(2% added) | | | |
| | invention | | | | | |
| 208 | Compound | Tank B: | compound | 78 | 77 | Present Invention |
| | 101 of the | polypropylene | P-1(2% added) | | | |
| | invention | (hydrotalcite | | | | |
| | | added) | | | | |

As can be seen from comparing Experiment 201 to 204 with Experiments 205 to 208, when the cyan

As can be seen from comparing Experiments 201 to 204 with Experiments 205 to 208, when the cyan color material is the comparative compound or when the ink-contacting member is polyethylene, influence of the addition of the water-soluble planar compound to the ink was found to be small. When both the cyan color material and the ink-contacting member were in accordance with the invention, it was found that addition of the water-soluble compound to the ink improved the ejection accuracy.

### Example 3

When evaluation was conducted under the conditions of Examples 1 and 2 using the cyan color materials 102, 108, 116, 136, 140, 158, 191, 192, 193, 194, 195, 196, 197 and 201 of the invention, there were shown good performance as with compound 101.

### Example 4

As comparative experiments on ink-contacting members, tanks were prepared using polyacetal, unsaturated polyester, PS, PET and PVC, and were evaluated under the conditions of Examples 1 and 2. However, combinations of the above-described members and the cyan color material of the invention were found to show no effect of improving ejection accuracy.

### Example 5

As to the ink-absorbing member adapted for an ink tank (BCI-3e (model No.; manufactured by Canon)), ink-absorbing members were prepared by using the same ink-contacting members as tanks A to M in Example 1. A combination of a cyan color material of the invention and an ink-contacting member of the invention gave good ejection accuracy.

The above-mentioned constitution of the invention can reduce the unevenness in the volume of an ejected ink and reduce deviation of an ink droplet-impacted position from an original position intended to impact in the case where the ink comes into contact with a ink-contacting member used in an ink jet recording apparatus for a long time at a comparatively low temperature or for a short time at a comparatively high temperature.

The entire disclosure of each and every foreign patent application from which the benefit of foreign priority has been claimed in the present application is incorporated herein by reference, as if fully set forth.

What is claimed is:

1. An ink unit comprising:
an ink for use in an ink jet recording apparatus; and
a liquid-contacting member that contacts with the ink,
wherein the ink comprises a phthalocyanine dye represented by formula (I) which has an oxidation potential of 1.0 V (vs SCE) or more, and
wherein a major component of the ink-contacting member is a polyolefin obtained by adding a hydrotalcite-like compound represented by formula (1): 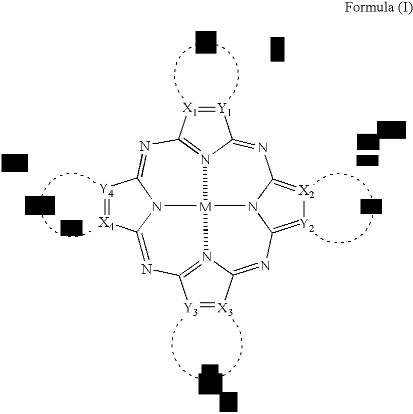
wherein X₁ to X₄ and Y₁ to Y₄ each independently represents a carbon atom or a nitrogen atom;
A₁ to A₄ each independently represents atoms necessary for forming an aromatic hydrocarbon ring or a hetero ring together with X₁ to X₄ and Y₁ to Y₄ and may further be condensed with other ring to form a condensed ring, provided that A₁ to A₄ may have a substituent, and at least one of A₁ to A₄ or at least one of substituents for A₁ to A₄ has a substituent capable of imparting solubility; and
M represents a hydrogen atom, a metal element, a metal oxide, a metal hydroxide or a metal halide:
[A₁₋ₓDₓ(OH)₂]^{x+}[E_{x/n}.mH₂O]^{x-} Formula (1)
wherein A represents a divalent metal;
D represents a trivalent metal;
E represents an n-valent anion;
m represents an integer; and
x satisfies relationship of 0<x≦0.5.

2. The ink unit according to claim 1,
wherein the hydrotalcite-like compound represented by formula (1) is a compound represented by formula of Mg₁₋ₓAlₓ(OH)₂(CO₃)_{x/2}.mH₂O, wherein x satisfies relationship of 0<x≦0.5.

3. An ink unit comprising:
an ink for use in an ink jet recording apparatus; and
a liquid-contacting member that contacts with the ink,
wherein the ink comprises a phthalocyanine dye represented by formula (I) which has an oxidation potential of 1.0 V (vs SCE) or more, and
wherein a major component of the ink-contacting member is a polyolefin obtained by adding at least one of a fatty acid and a fatty acid derivative: 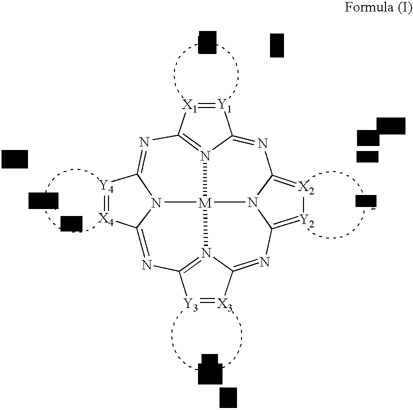
wherein X₁ to X₄ and Y₁ to Y₄ each independently represents a carbon atom or a nitrogen atom;
A₁ to A₄ each independently represents atoms necessary for forming an aromatic hydrocarbon ring or a hetero ring together with X₁ to X₄ and Y₁ to Y₄ and may further be condensed with other ring to form a condensed ring, provided that A₁ to A₄ may have a substituent, and at least one of A₁ to A₄ or at least one of substituents for A₁ to A₄ has a substituent capable of imparting solubility; and
M represents a hydrogen atom, a metal element, a metal oxide, a metal hydroxide or a metal halide.

4. An ink unit comprising:
an ink for use in an ink jet recording apparatus; and
a liquid-contacting member that contacts with the ink,
wherein the ink comprises a phthalocyanine dye represented by formula (I) which has an oxidation potential of 1.0 V (vs SCE) or more, and
wherein a major component of the ink-contacting member is a polyolefin obtained by adding a phenol series antioxidant: 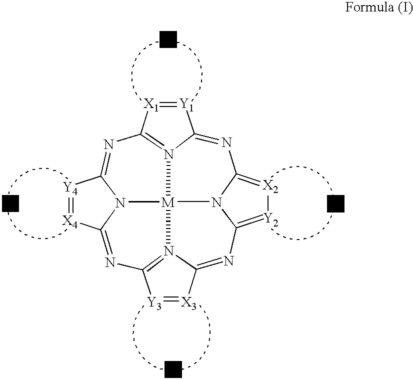
wherein X₁ to X₄ and Y₁ to Y₄ each independently represents a carbon atom or a nitrogen atom;
A₁ to A₄ each independently represents atoms necessary for forming an aromatic hydrocarbon ring or a hetero ring together with X₁ to X₄ and Y₁ to Y₄ and may further be condensed with other ring to form a condensed ring, provided that A₁ to A₄ may have a substituent, and at least one of A₁ to A₄ or at least one of substituents for A₁ to A₄ has a substituent capable of imparting solubility; and
M represents a hydrogen atom, a metal element, a metal oxide, a metal hydroxide or a metal halide.

5. An ink unit comprising:
an ink for use in an ink jet recording apparatus; and
a liquid-contacting member that contacts with the ink,
wherein the ink comprises a phthalocyanine dye represented by formula (I) which has an oxidation potential of 1.0 V (vs SCE) or more, and
wherein a major component of the ink-contacting member is a polyolefin obtained by adding a benzylidenesorbitol: 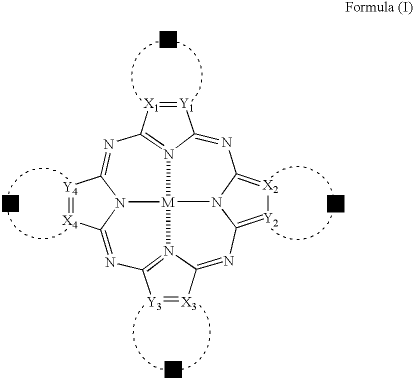
wherein X₁ to X₄ and Y₁ to Y₄ each independently represents a carbon atom or a nitrogen atom;
A₁ to A₄ each independently represents atoms necessary for forming an aromatic hydrocarbon ring or a hetero ring together with X₁ to X₄ and Y₁ to Y₄ and may further be condensed with other ring to form a condensed ring, provided that A₁ to A₄ may have a substituent, and at least one of A₁ to A₄ or at least one of substituents for A₁ to A₄ has a substituent capable of imparting solubility; and
M represents a hydrogen atom, a metal element, a metal oxide, a metal hydroxide or a metal halide.

6. The ink unit according to claim 1,
wherein the phthalocyanine dye is a dye represented by formula (II): 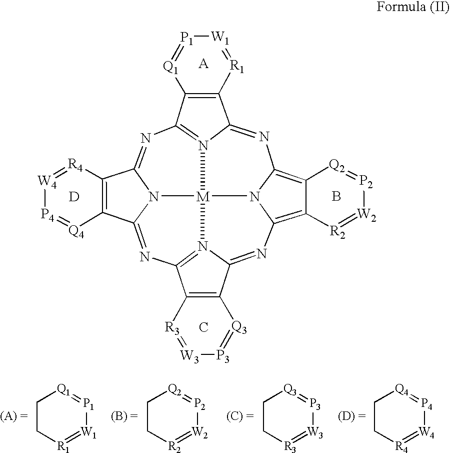
wherein Q₁ to Q₄ each independently represents ═C(J₁)- or —N═;
P₁ to P₄ each independently represents ═C(J₂)- or —N═;
W₁ to W₄ each independently represents ═C(J₃)- or —N═;
R₁ to R₄ each independently represents ═C(J₄)- or —N═;
J₁ to J₄ each independently represents a hydrogen atom or a substituent, provided that at least one of J₁ to J₄ is a substituent capable of imparting solubility or at least one of substituents which J₁ to J₄ have is a substituent capable of imparting solubility; and
M is the same as defined with respect to the formula (I).

7. The ink unit according to claim 1,
wherein the polyolefin is a polypropylene.

8. The ink unit according to claim 1,
wherein the ink-contacting member is an ink-contacting member of at least one of an ink tank and an ink jet cartridge.

9. The ink unit according to claim 1,
wherein the ink-contacting member is an ink-contacting member of an ink absorbing member.

10. The ink unit according to claim 1,
wherein the ink-contacting member is an ink-contacting member of at least one of a tube of ink-supplying system, a common path in a head, a pressure chamber in a head and a nozzle in a head.
